(19) United States
(12) Patent Application Publication
(10) Pub. No.: US 2018/0180752 A1
(43) Pub. Date: Jun. 28, 2018

(54) METHOD AND A SYSTEM FOR LOCATING A MOBILE TELEPHONE

(71) Applicant: WIZEDSP LTD., TEL-AVIV (IL)

(72) Inventor: OZ GABAI, TEL-AVIV (IL)

(21) Appl. No.: 15/738,626

(22) PCT Filed: Jun. 22, 2016
(86) PCT No.: PCT/IB2016/053700

§ 371 Date: Dec. 21, 2017

Related U.S. Application Data
(60) Provisional application No. 62/182,778, filed on Jun. 22, 2015.

(51) Int. Cl. G01V 1/00

(52) U.S. Cl. CPC G01V 1/001

(57) ABSTRACT

An ultra-low-power acoustic locator circuitry for locating a battery operated device when the battery is dead, or when a mobile communication device is set to silent mode.

### CROSS-REFERENCE TO RELATED APPLICATIONS

This application claims the benefit of U.S. Provisional Application No. 62/182,778, filed Jun. 22, 2015, the disclosure of which is incorporated herein by reference in its entirety.

### FIELD

The method and apparatus disclosed herein are related to the field of device location, and, more particularly but not exclusively, to acoustic locators.

### BACKGROUND

Mobile telephones a frequently displaced, or forgotten, requiring the owner of the mobile telephone to locate the device. The intuitive operation is to dial the number of the lost mobile telephone and follow the ringing sound. The problem with this method is that the mobile telephone may be in silent mode, or its battery may be empty. In both such cases, as other, similar cases, dialing the number of the lost mobile telephone may not work. There is thus a widely recognized need for, and it would be highly advantageous to have, a loudspeaker that overcomes the above limitations.

### SUMMARY

According to one exemplary embodiment, there is provided an acoustic locator including: a microphone sensor, an energy system, and an ultra-low-power acoustic transceiver, electrically coupled to the microphone and to the energy system, and operative in a frequency range of 14000 Hz-20000 Hz.

According to another exemplary embodiment, the ultra-low-power acoustic transceiver includes an acoustic modem having an input electrically coupled to least one of an electrets microphone and a MEMS microphone, and an output electrically coupled to at least one of a speaker and an electrostatic speaker.

According to yet another exemplary embodiment, the ultra-low-power acoustic transceiver is additionally electrically coupled to at least one of a supply voltage, a switch which is normally turned off, and an ultra-low-power acoustic wakeup receiver.

According to still another exemplary embodiment, the ultra-low-power acoustic transceiver additionally includes an ultra-low-power acoustic wakeup receiver including: an ultra-low-power input buffer/amplifier electrically coupled to least one of an electrets microphone and a MEMS microphone, an ultra-low-power low-noise amplifier, an ultra-low-power amplifier, an ultra-low-power active band-pass filter, an envelope/energy detector, a first delay unit, a comparator configured to compare between the instantaneous envelope energy and delayed energy, a second delay unit connected to the comparator output, a detector circuit configured to detect a threshold of at least one of voltage and current on the second delay, and a memory unit configured to store the state of detection, which is connected to the threshold detector.

Further according to another exemplary embodiment, at least one of the first and second delay comprises a passive low-pass-filter.

Yet further according to another exemplary embodiment, the threshold detector includes at least one of a Schmidt-trigger buffer and a Schmidt-trigger inverter.

Still further according to another exemplary embodiment, the threshold detector includes a first comparator and a second threshold voltage connected to one node of comparator input.

Even further according to another exemplary embodiment, the threshold detector includes at least one of a BJT transistor, a MOSFET transistor, and a JFET transistor.

Additionally, according to another exemplary embodiment, the energy system includes: an energy system circuit, a first battery, a second super-capacitor, and a temperature control circuit to disconnect the battery from the energy circuit whenever temperature is out of a predefined temperature range.

According to still another exemplary embodiment, the energy system includes an energy system circuit, a first battery, a second super-capacitor, a third energy harvested unit, and a temperature control circuit to disconnect the battery from the energy circuit whenever temperature is out of a predefined temperature range

According to yet another exemplary embodiment, the energy system includes: an energy system circuit, a first battery, a second super-capacitor, a third energy harvested unit, and a temperature control circuit to disconnect the battery from the energy circuit whenever temperature is out of a predefined temperature range.

Further according to another exemplary embodiment, the energy system includes: an energy system circuit, a first battery, a second super-capacitor, a third energy harvested unit, a fourth external energy source, and a temperature control circuit to disconnect the battery from the energy circuit whenever temperature is out of a predefined temperature range.

Still further according to another exemplary embodiment, the energy circuit includes a charging circuit for the super-capacitor.

Yet further according to another exemplary embodiment, the charger is based on a constant current with a comparator that limits charging operation when voltage on the super-capacitor reaches a predefined voltage.

Even further according to another exemplary embodiment, the energy circuit includes: a first battery disconnection circuit to disconnect the battery whenever temperature is out of a predefined temperature range, a second charging unit to charge the super-capacitor, having two inputs for source of energy, where a first input is the battery, and a second input is an external source, and a third charging unit to charge the battery from the external source.

Additionally, according to another exemplary embodiment, the energy circuit includes: a first battery disconnection circuit to disconnect the battery whenever the temperature beyond a predefined temperature range, and a second charging unit to charge the super-capacitor, having two inputs for source of energy, where the first is the battery, and the second is the external source.

Further according to another exemplary embodiment, there is provided an acoustic locator including: a microphone, a speaker, an ultra-low-power acoustic transceiver, a battery, a super-capacitor, and a memory storing RF network connection I.D.

Still further according to another exemplary embodiment, the acoustic locator additionally includes a Global Positioning System (GPS) having dial-able control line putting the GPS on standby for low power.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1A is a simplified block-diagram of an ultra-low-power acoustic cellphone and/or mobile phone or headset locator;

FIG. 1B is a block diagram of an ultra-low-power locator embedded in a mobile device such as a smartphone;

FIG. 1C is a block diagram of an ultra-low-power locator embedded in a mobile device such as a Bluetooth headset;

FIG. 1D is a simplified illustration of an acoustic transmitter;

FIG. 1E is a simplified block diagram of the electric circuit of the acoustic transmitter;

FIG. 1F is a simplified illustration of a bidirectional acoustic transmitter;

FIG. 1G is a simplified block diagram of the electric circuit of the acoustic transmitter of FIG. 1F;

FIG. 2 is a block-diagram of a programming process;

FIG. 3A is a simplified flow-chart of a process of programming a unique address in the case of hearing device such as Bluetooth hearing device;

FIG. 3B is a simplified flow-chart of a process of connecting hearing device such as Bluetooth hearing device via Bluetooth;

FIG. 3C is a simplified flow-chart of a process of setting an address code, or ID;

FIG. 4 is a simplified block-diagram of an energy system of a locator device such as the locator of in FIG. 1A;

FIG. 5A is a simplified block-diagram of an ultra-low-power protocol;

FIG. 5B is a simplified diagram of an ultra-low-power protocol in time-frequency domain;

FIG. 6 is a simplified illustration of a WakeUp signal modulation;

FIG. 7 is a simplified illustration of a state machine of the ultra-low-power acoustic transceiver;

FIG. 8A is a simplified block-diagram of an ultra-low-power signal detection circuit, according to one exemplary embodiment. FIG. 8A is an example of a standby detector.

FIG. 8B is a simplified diagram of an ultra-low-power standby signal detection waveform;

FIG. 8C is a simplified diagram of an Electret condenser microphone with no buffer;

FIG. 8D is a simplified diagram of a MEMS microphone with no buffer;

FIG. 9 is a simplified electric diagram of a MOSFET microphone buffer circuitry;

FIG. 10 is a simplified electric diagram of a JFET microphone buffer circuitry;

FIG. 11A is a simplified electric diagram of a bidirectional noise blocking filter (LPF);

FIG. 11B is a simplified electric diagram of a noise blocking filter (LPF) from the output of the OP amplifier to RB;

FIG. 12 is a simplified electric diagram of a low-noise-amplifier (LNA) using MOSFET with LPF filters to reject noise from an op amplifier;

FIG. 13 is a simplified electric diagram of a low-noise-amplifier (LNA) using JFET with LPF filters to reject noise from an op amplifier;

FIG. 14A is a simplified block-diagram of an active filter;

FIG. 14B is a simplified block-diagram of a two-stage active filter;

FIG. 14C is a simplified block-diagram of a2nd Order Band Pass Filter;

FIG. 15 is a simplified block-diagram of a single-stage, ultra-low-power, active filter using MOSFET with noise blocking filters;

FIG. 16 is a simplified block-diagram of a single-stage, ultra-low-power, active filter using JFET with noise blocking filters;

FIG. 17A is a simplified symbol of an ultra-low-power voltage buffer;

FIG. 17B is a simplified diagram of a wire implementation of the ultra-low-power voltage buffer of FIG. 17A;

FIG. 17C is a simplified diagram of a possible implementation of the ultra-low-power voltage buffer of FIG. 17A with JFET;

FIG. 17D is a simplified diagram of a possible implementation of the ultra-low-power voltage buffer of FIG. 17A with MOSFET;

FIG. 18A is a simplified diagram of a of an envelope and/or energy detector;

FIG. 18B is a simplified illustration of an input signal;

FIG. 18C is a simplified illustration of an output signal on RD and output of LPF;

FIG. 19A is a simplified illustration of a floor plan of an acoustic locator;

FIG. 19B is a simplified illustration of a side view of an acoustic locator module;

FIG. 19C a simplified illustration of a microphone/speaker acoustic transducer; and

FIG. 20 is a simplified block diagram of a combination of an acoustic locator with wireless networks and a GPS device.

### DETAILED DESCRIPTION

The present invention in embodiments thereof comprises systems and methods for acoustic locator for a mobile telephone or any other mobile device, or portable device or battery-operated device. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of embodiments described below is to provide at least one system and/or method for locating a mobile telephone, or any other mobile device, or portable device or battery-operated device using acoustic communication However, the systems and/or methods as described herein may have other embodiments in similar technologies of local area communication.

For example, an acoustic module, may use the acoustic frequency band in the 14000 Hz-20000 Hz bandwidth, to carry information using acoustic waves. The frequency band of 14000 Hz-20000 Hz is selected as there is relatively low ambient acoustic energy in the band, which may generate noise regarding the acoustic communication. Therefore, the acoustic locator may have a higher gain, and/or lower power consumption, and/or support more robust data communication.

The acoustic locator is based on an ultra-low power microphone, a robust acoustic ultra-low power transceiver, and an energy system which may be based on a coin battery, and might also have a super-capacitor and a connection to the cell phone/hearing device internal battery.

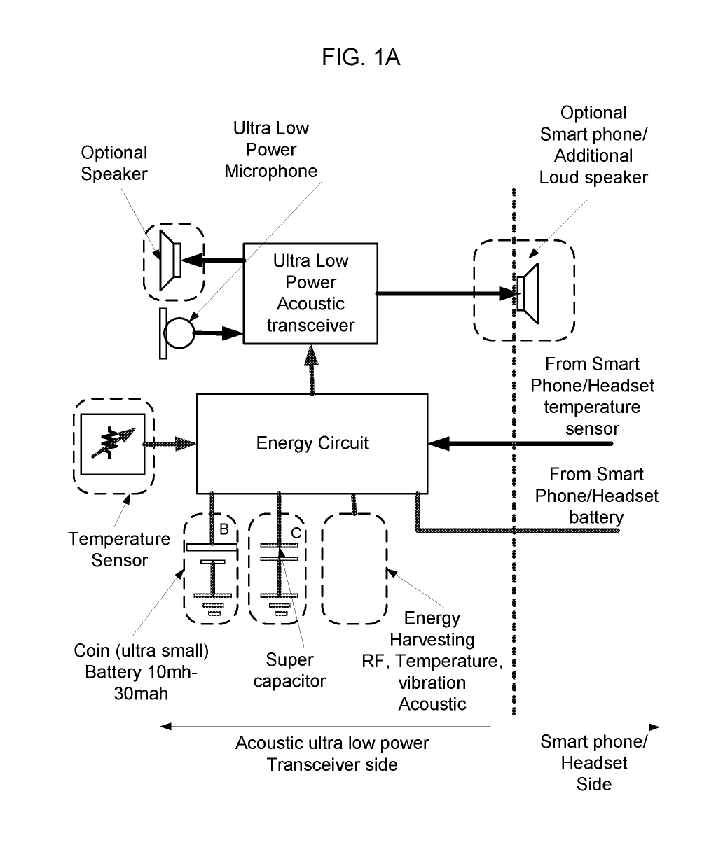

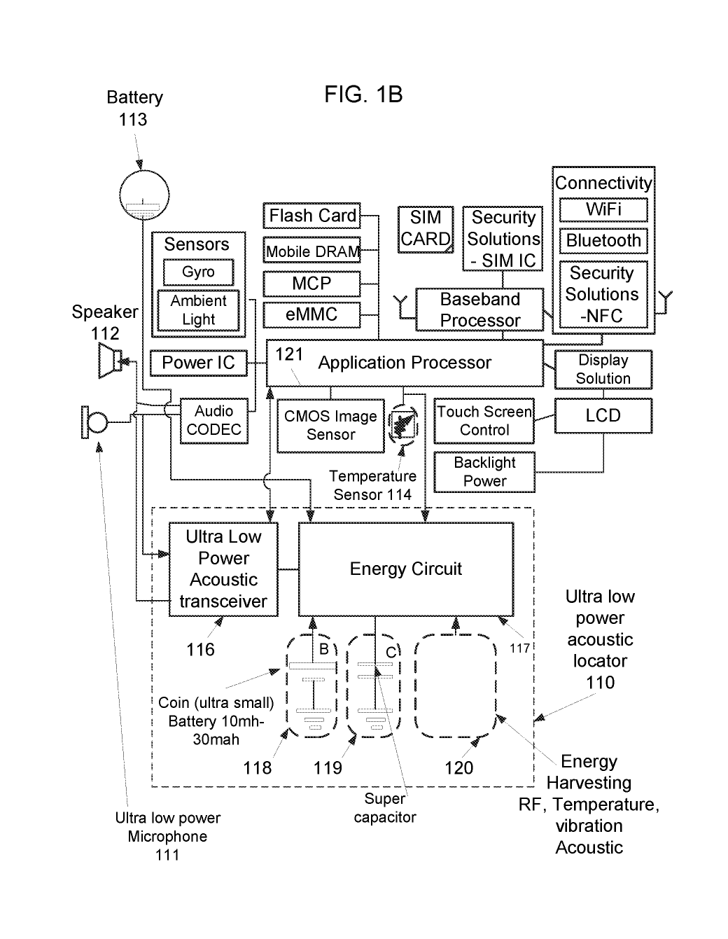

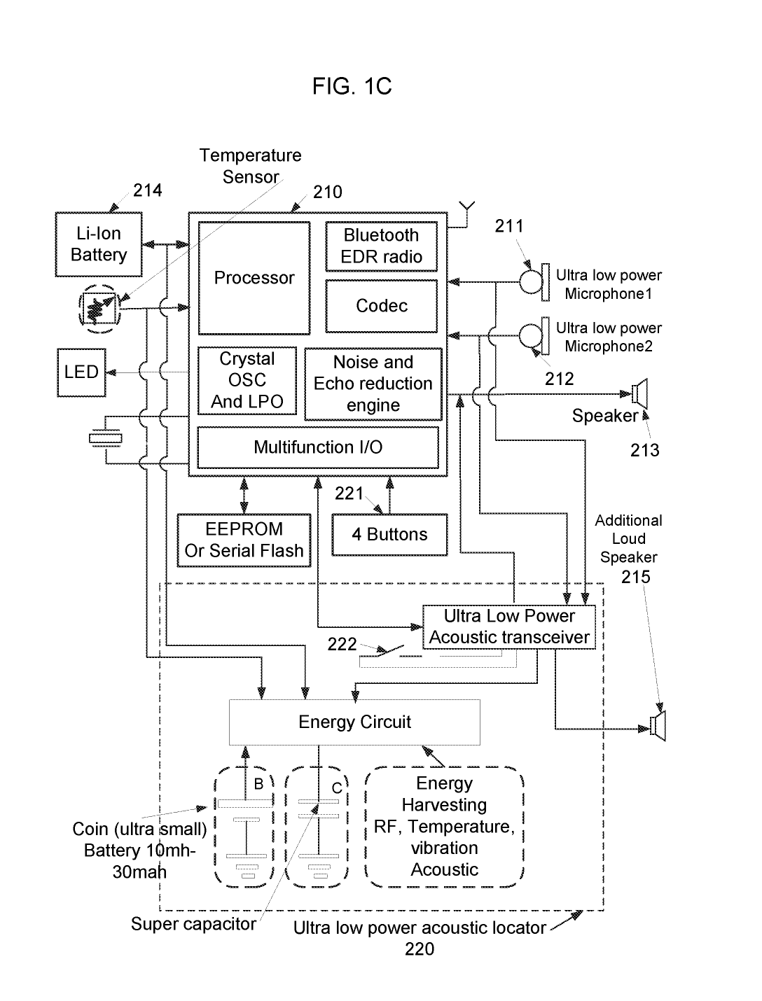

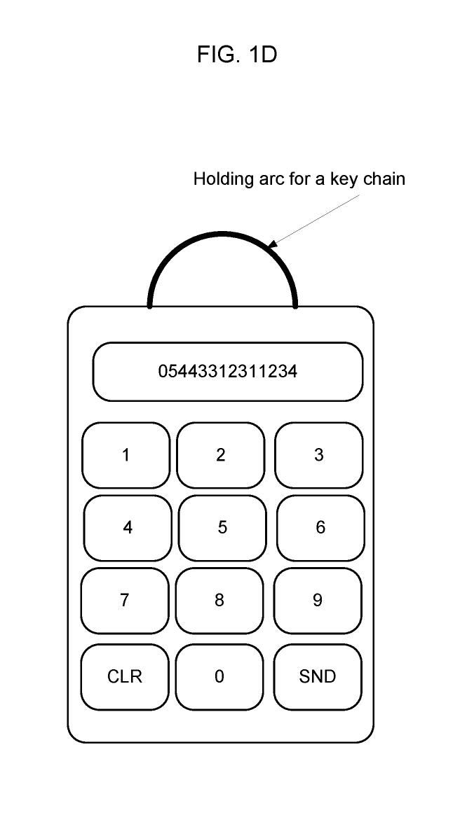

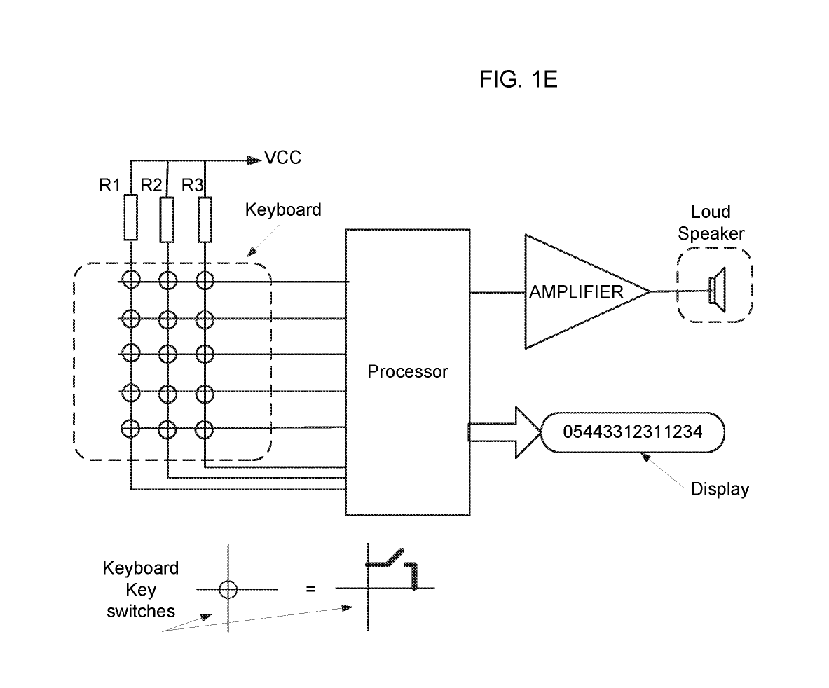

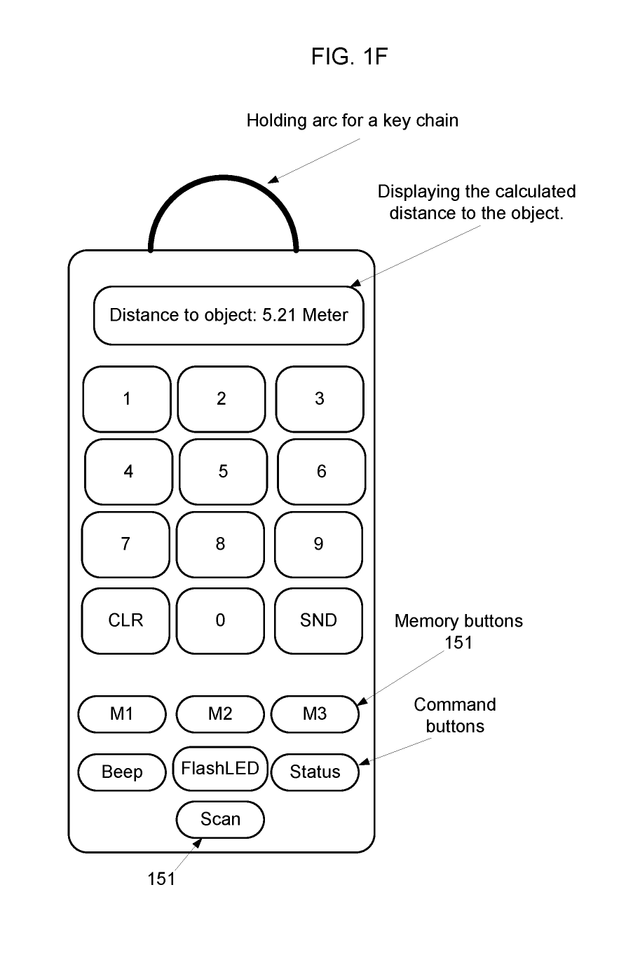

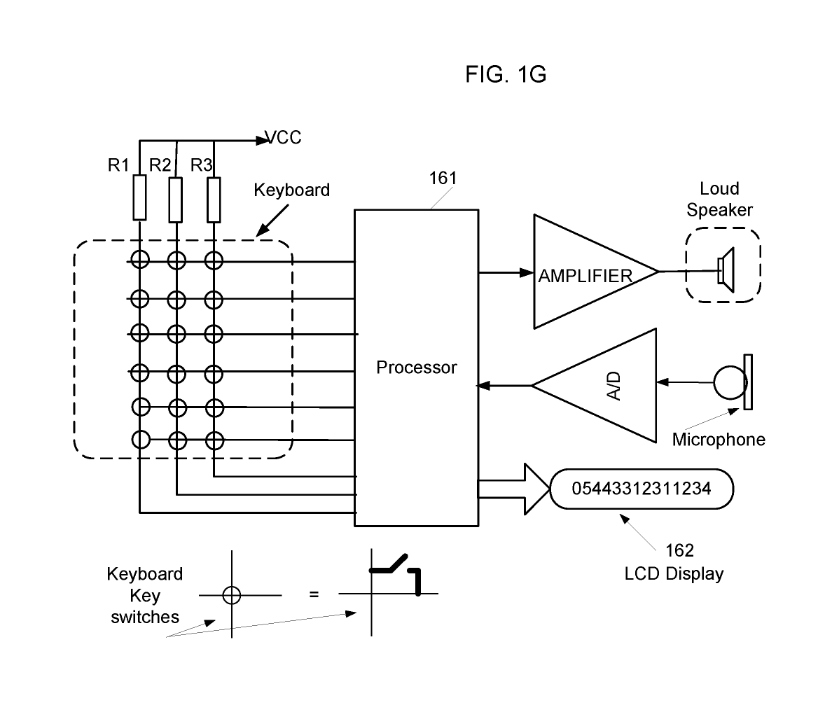

FIG. 1A is a simplified block-diagram of an ultra-low-power acoustic cellphone and/or mobile phone or headset locator, according to one exemplary embodiment.

The system of FIG. 1A may receive energy (that is power) from up to four energy sources:

The most common source may be a small battery with a low capacity of 10 mah-30 mah. For example, if a CR2032 battery with a diameter of 20 mm and a height of 3.2 mm, has about 230 mah, then the designated battery of the invention can be about 1/23 smaller in volume. This battery can then have a diameter of 6 mm with a thickness of 1.5 mm. We can use a rechargeable or a normal battery for that purpose.

A Supper capacitor, which may be charged from the cell phone or from the Bluetooth Headset internal battery or internal battery charger.

An energy harvesting module that may be based on any technology such as: Radio Frequency (RF) harvesting, temperature variation harvesting, vibration harvesting, and/or acoustic harvesting.

The energy circuit may be connected to a temperature sensor on the left, or can receive a temperature sensing data from the cell phone/Bluetooth headset. The temperature sensor/signal data is needed to provide safe operation of the locator battery charger. In some batteries in the market, the safe operation of the battery is within 0 degrees to 40 degrees Celsius. In other cases where the temperature exceeds the temperature boundaries, upper than the maximum level or lower than minimum level, the battery should be disconnected from the energy circuit. Disconnecting the battery is done internally by the energy circuit. In such cases, even without a battery, the ultra-low-power locator would work using the stored energy in the super-capacitor, which has a higher temperature range then the rechargeable battery.

FIG. 1B is a block diagram of an ultra-low-power locator embedded in a mobile device such as a smartphone, according to one exemplary embodiment . . . .

FIG. 1B shows an example of a smartphone block diagram, where, the acoustic locator 110, is embedded inside the smartphone. We can see that the smartphone is using an ultra-low-power microphone 111, and this microphone is used for both voice communication and acoustic communication. The ultra-low-power acoustic transceiver 116, is also connected to the smartphone's speaker 112, which can be used to transmit acoustic data. The Ultra-low-power acoustic transceiver 116, receives power from the energy circuit 117. The energy circuit 117 is connected to the smartphone's battery 113. As long there is sufficient power in the smartphone's battery 113, the super-capacitor 119 may be charged if required, and the ultra-low acoustic transceiver may receive power from the smartphone's battery 113. Once the smartphone's battery is dead, the Ultra-low-power acoustic transceiver 116, may receive energy from the Super-capacitor 119. If the smartphone's battery 113 is empty and the Super-capacitor 119 is empty, then the Ultra-low-power acoustic transceiver 116, may receive energy from the coin battery 118.

FIG. 1C is a block diagram of an ultra-low-power locator embedded in a mobile device such as a Bluetooth headset, according to one exemplary embodiment . . . .

FIG. 1C shows an example of a Bluetooth headset block diagram, where, the acoustic locator 220, is embedded inside the hardware of a Bluetooth headset. The locator can be embedded in any kind of hearing device such as hearing aids. We can see that the Bluetooth headset is using ultra-low-power microphones 211 and 212. These microphones are used for both voice communication and acoustic communication. The ultra-low-power acoustic transceiver is connected to an additional speaker 215 which may be used to transmit acoustic data and also to generate loud beeping tones to guide the user to the location of the lost headsets. The ultra-low-power acoustic transceiver can also be connected to the Bluetooth headset's speaker 213. The Ultra-low-power acoustic transceiver, receives power from the energy circuit. The energy circuit is connected to the Bluetooth headset's battery 214. As long there is sufficient power in the headset's battery 214, the super-capacitor may be charged, and the ultra-low acoustic transceiver may receive power from the Bluetooth headset's battery 214. Once the Bluetooth headset's battery is dead, the Ultra-low-power acoustic transceiver, may receive energy from the Super-capacitor. If the Bluetooth headset's battery 214 is empty and the Super-capacitor is empty, then the Ultra-low-power acoustic transceiver, may receive energy from the coin battery.

A method for locating a smartphone or a Bluetooth headset device.

Once an acoustic message is decoded by the ultra-low-power acoustic transceiver 116, then the acoustic transceiver may typically generate a loud beep using the smartphone's speaker 112, in order to guide the user to his lost smartphone described in FIG. 1B. If the smartphone's battery 113 is not empty, then the ultra-low-power acoustic transceiver 116, may also send a message to the application processor 121 of the smartphone, to let the application know that the user trying to locate his phone. Once the Application processor receives such a message, it can flash the camera LED and in addition open the smartphone's GPS and try to check if it can locate the phone's location. That location can be sent to an email address that the user has specified for such cases, or as an SMS message to another phone number.

The smartphone's locator device described in FIG. 1A, is typically embedded inside of the smartphone, by the manufacture of the phone. The Bluetooth headset locator described in FIG. 1A, is also typically embedded inside of the headset by the manufacture of the headset. Each one of these locators, described in FIG. 1A, has a unique ID number. When operating, the locator device uses its microphone to detect acoustic communication signals. Once an acoustic signal is detected, the locator may then start its internal acoustic modem to analyze the signal data. If the data has its unique ID number, the locator may typically generate a loud beep signal. The loud beeping sound may guide the user to find his lost phone usually in the home or office.

The unique ID number may usually be pre-programmed by the manufacturer. However, it can be re-programmed by the user. This ID number can typically be constructed by user to include its own telephone number, and while having an additional pin code number. For example, if a user would like to re-program its internal locator unique ID number, and having for example, a telephone number: 054-4331231. This user then should choose a secret PIN number, for example 1234. So In this case, the unique ID number which the user may choose to program into the locating device, may be: 05443312311234, where, the 0544331231 is the mobile phone number and the 1234 is the pin code.

If this user also possesses a Bluetooth headset, then he can program the headset to have a similar ID number which has a different pin code. In this example the unique ID code for the Bluetooth headset may be 05443312311235 (the only difference is the 4 digits pin number at the end). Programming a Bluetooth headsets unique ID number can be performed by downloading an application to the smartphone, and once the smartphone is paired with the Bluetooth headset, the user can use the application to enter his unique ID number and program the Bluetooth headset.

The unique ID number the user creates can also include a unique serial or code number of the processor running the acoustic modem in the locator (we can call it the Modem address). Usually the modem address is hardware masked and cannot change.

In order to locate the mobile phone or the Bluetooth headset, a user would need to use another mobile phone or a tablet or a personal computer (PC) or an acoustic transmitter to generate the required acoustic signal which contains the specific unique ID of the device. An example to that process may be using a PC or a tablet or a phone which is equipped with speakers. The user may download an application to the PC/tablet/phone, or may use a web service, that may ask him to enter the unique ID number of the device he is trying to locate. Then the application may first try to set the volume to maximum, and then may generate the required acoustic signal that may be emitted using the loud speakers.

FIG. 1D is a simplified illustration of an acoustic transmitter, according to one exemplary embodiment. FIG. 1D shows an example of an acoustic transmitter, which may be attached to a key chain, and may be as small as 3 cm×4 cm×0.5 cm.

FIG. 1E is a simplified block diagram of the electric circuit of the acoustic transmitter, according to one exemplary embodiment.

In order to locate a lost smartphone (or a lost Bluetooth headset), using the acoustic transmitter, the user may need to enter the smartphone's unique ID number as described earlier. Typically, the user may choose this unique ID number based on his telephone number, with an additional PIN code number. The acoustic transmitter can have an additional programming button that may enable the user to store the unique ID number. The acoustic transmitter can also have a few memory buttons, to store a few different unique ID numbers, each for a different locator product.

Pressing on the SND key may cause the Processor of the acoustic transmitter of FIG. 1B to execute its acoustic modem and to generate an acoustic modem signal that has a unique ID as its payload data.

Once a locator device as described in FIG. 1A or FIG. 1B or FIG. 1C, detects an acoustic signal, it may then execute its internal modem and check to see if this signal refers to its unique ID number. If there is a match, the locator may typically generate a loud beep tone that may guide the user to locate his device.

FIG. 1F is a simplified illustration of a bidirectional acoustic transmitter, according to one exemplary embodiment.

FIG. 1G is a simplified block diagram of the electric circuit of the acoustic transmitter of FIG. 1F, according to one exemplary embodiment.

The acoustic transmitter can also become a transceiver device as seen in FIG. 1F and FIG. 1G, which can also receive acoustic messages. In this case, as described in FIG. 1G, it may also have a microphone, and typically an LCD display 162 and a few command buttons, which can generate different commands to the locator device of FIG. 1A. These commands can include a command to emit a loud beep tone, or to emit a flashing LED light, or for example to transmit a status message. A status message can include for example the battery status of the locator 118, and the information can be displayed on the LCD. Measuring the time it takes for the reply to arrive to the Special Acoustic Transceiver of FIG. 1G, and knowing the speed of sound, may enable processor of the Special Acoustic Transceiver 161, to calculate the distance to the locator device of FIG. 1A. The calculated distance can then be displayed on the LCD 162 in order to help guide the user to the location of the lost device.

The transceiver device of FIG. 1F and FIG. 1G, can also acquire various unique locator IDs of various products. It can have an additional “scan” button, and an algorithm to wait for a received acoustic message. The locator device of FIG. 1A, can have an additional button that can enable the user to broadcast its unique ID number. In this example, the user may press on the “Scan” button of the Special Transceiver Device 151, and then may press on the broadcast button of the locator device (this button can be for example of the buttons of a Bluetooth headset 221, or a virtual button in an application running in the smartphone of FIG. 1B). Once the Special Transceiver Device of FIG. 1G, detects this broadcast message, it can display the detected ID and allow the user to store it in one of the memory buttons 151. The broadcast button can be a physical button in the locator device, like a small button in a Bluetooth headset 222, having an internal locator device of FIG. 1C. The broadcast functionally can also be programmed into an application of a smartphone of FIG. 1C, which has a locator device of FIG. 1A embedded inside. By a long pressing on a dedicated button 222 on the acoustic locator, the acoustic locator 220 can advertise (or broadcast) its unique modem ID address. The ID may be transmitted by the acoustic modem. Then the acoustic transceiver of FIG. 1G can detect the unique ID and store it in a memory table. As explained before, the unique ID can include the Modem address of the locator, and this number can be broadcasted too by the locator. The acoustic transceiver of FIG. 1G may then store in that memory table also the unique Modem address. This method may enable the acoustic transceiver of FIG. 1G to store both the user defined ID, and alongside the Modem address.

To locate a smartphone or a Bluetooth headset, the user can use another smartphone or tablet or a PC which has the locator application installed. The locator application would allow the user to enter the lost device's unique ID number. Then, by pressing send on the application, the generate an acoustic signal in the range of 14000 Hz-20000 Hz which encodes the unique ID number of the locator of the lost device. For example, the number 05443312311234. Once played, this acoustic signal may propagate and would be received by the Ultra-low-power acoustic locator 110, which in turn may turn on the loud speaker 112 sounding some kind of a beep which may guide us to locate our lost smartphone.

The unique address of the cell phone/Bluetooth headset hearing device may be any string of ASCII characters.

The operation of locating the cell phone via an acoustic transmitter of FIG. 1D, which may be small enough to be put with a key chain, or in some known place around the house/office, this acoustic transmitter, would have a key board for entering the unique address of the cell phone/hearing device and by pressing send the acoustic transmitter may generate acoustic wave that would be transmitted using a loud speaker, modulated by the unique key.

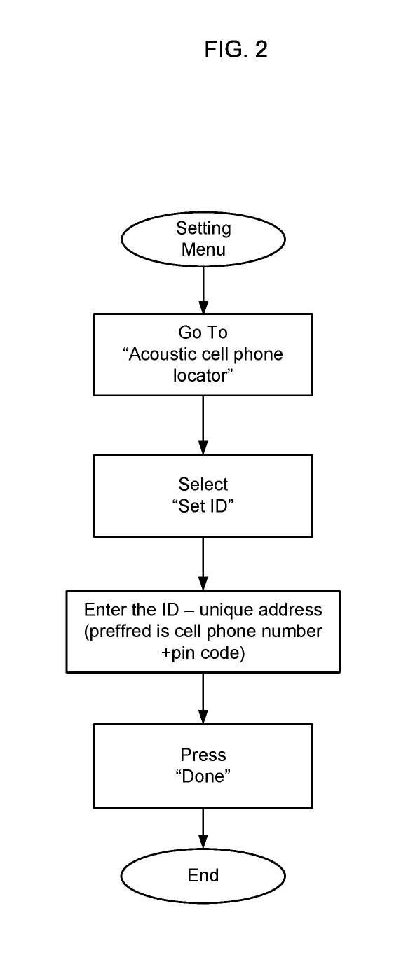

FIG. 2 is a block-diagram of a programming process, according to one exemplary embodiment.

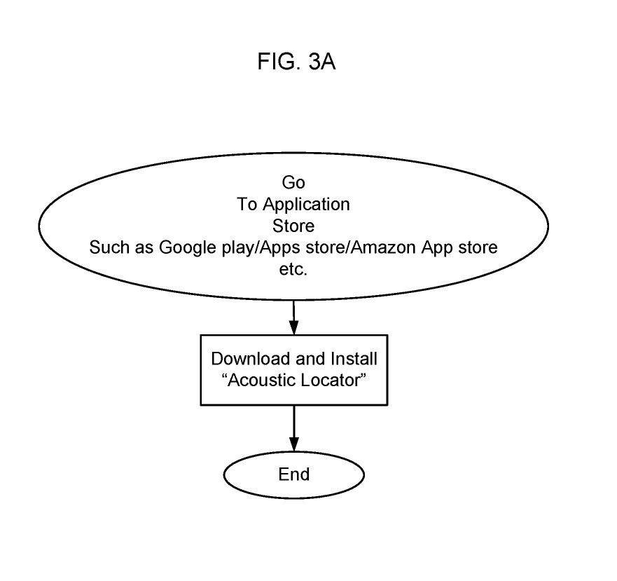

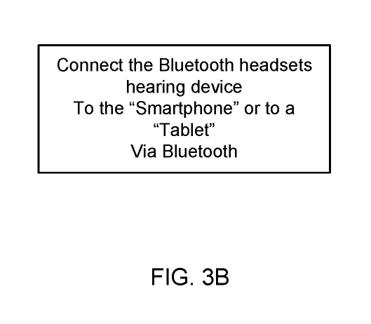

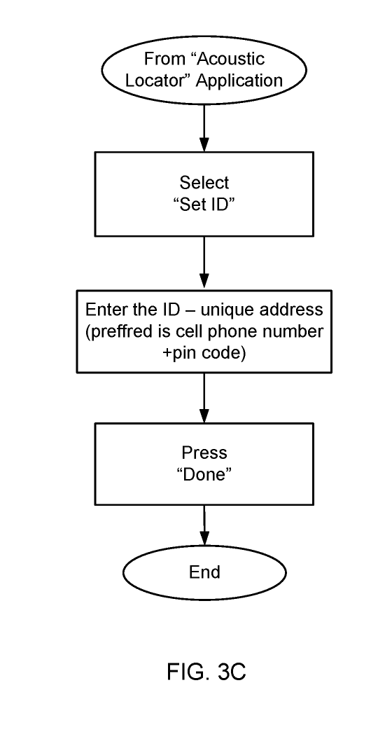

FIG. 2, shows the process of programming the unique address/code of the smartphone while FIG. 3 shows the process of programming the unique address/code of the Bluetooth headset hearing device via Bluetooth and using a smart phone/tablet application. Such programming of the unique code in a smartphone may be used, for example, when the acoustic locator is embedded into the smartphone hardware.

When the acoustic locator is part of the smartphone hardware as described in FIG. 1B, then accessing the unique address/code programming menu is done via the “setup” menu of the operating system. Typically, the user may choose to go to “Acoustic smartphone locator”, and from there he may have several menus keys. These keys may enable getting a battery status of the acoustic locator, and enable setting the unique ID code. Pressing on “Set ID” can enable entering a unique address/code ID, and as suggested earlier, it may typically be constructed as a <Cell Phone Number>+<PIN code>. The user can find it easy to remember. The PIN code may be an ASCII string of characters, for example, if the cell phone number is 054-4331231, then the unique address may be 0544331231JOECELLPHONE or just 0544331231JOE.

The acoustic locator may be a part of a Bluetooth headset hearing device hardware as of FIG. 1C. The headset is usually very small and does not include an LCD screen. So the easiest way to program the unique ID code of the headsets, may be using the smartphone which may be paired with the Bluetooth headsets. Another way may be using acoustic communication to setup and control the locator device. In order to program a hearing device using acoustic communication, the hearing device should have a microphone 211 and a speaker 213 as described in FIG. 1C. This may enable establishing two way communication for receiving the acoustic messaging and for transmitting back the messaging to the smartphone/cell phone/tablet/computer or any device connected to the headsets.

In such case the programming may be done via an application.

FIG. 3A is a simplified flow-chart of a process of programming a unique address in the case of hearing device such as Bluetooth hearing device, according to one exemplary embodiment.

FIG. 3B is a simplified flow-chart of a process of connecting hearing device such as Bluetooth hearing device via Bluetooth, according to one exemplary embodiment.

FIG. 3C is a simplified flow-chart of a process of setting an address code, or ID, according to one exemplary embodiment.

The flow-charts of FIG. 3A to FIG. 3C show a process of programming the Bluetooth headsets hearing device unique address via an application and a Bluetooth connection.

In the case where the acoustic locator is part of the hearing device HW, such as Bluetooth hearing device, the programming of the unique address may be done via an application and a Bluetooth connection.

FIG. 3A to FIG. 3C, describe the preferred process. FIG. 3A shows how to install the “Acoustic locator” application. FIG. 3B shows the connection of the hearing device to q smartphone or q tablet via Bluetooth. Pairing is normally done by searching a nearest Bluetooth network and performing along pressing on the key located on the hearing device causing it to send its beacon. FIG. 3C shows the programming of the unique address via the “acoustic locator” application.

The acoustic locator size is probably similar to a Micro Electronic Mechanical Systems (MEMS) microphone, which is 3 mm×4 mm×1.5 mm. This tiny circuit may be attached to many other devices, such as “glasses”, smartphone's cover case protectors, key chains, and many others device. One of the benefits of using the “acoustic locator” compared to a BLE locator, is the enhanced working time compared to the BLE solutions. Acoustic locator device may typically use a small battery of 10 mah-30 mah, which is 1/23 smaller in volume then a CR2032 battery which is normally used by the BLE locators (the BLE locators would usually work about 4-8 months using CR2032 battery).

In cases where in the acoustic locator system module is used as a general locator component which is not embedded inside the hardware of a smart device, then programming it may be handled using acoustic connection. Connecting to such locator module can typically be done in a similar way as pairing with a Bluetooth device. A long press on a button located on the locator housing (button 222 in FIG. 1C), may cause the acoustic locator to send its modem address (or the complete unique ID) repeatedly via a known frequency band for a few seconds. At that time, an application on a tablet or a smartphone like the one described on FIGS. 3A and 3B, may have a button “Connect” or “Scan”. Then by pressing the connect button, the smartphone/tablet may get the acoustic locator modem address. Knowing the modem address or the unique ID code, may later enable the application to communicate and program the acoustic locator. Programming the unique ID of the acoustic locator is typically done in the same way as described by FIG. 3C

Energy System Description

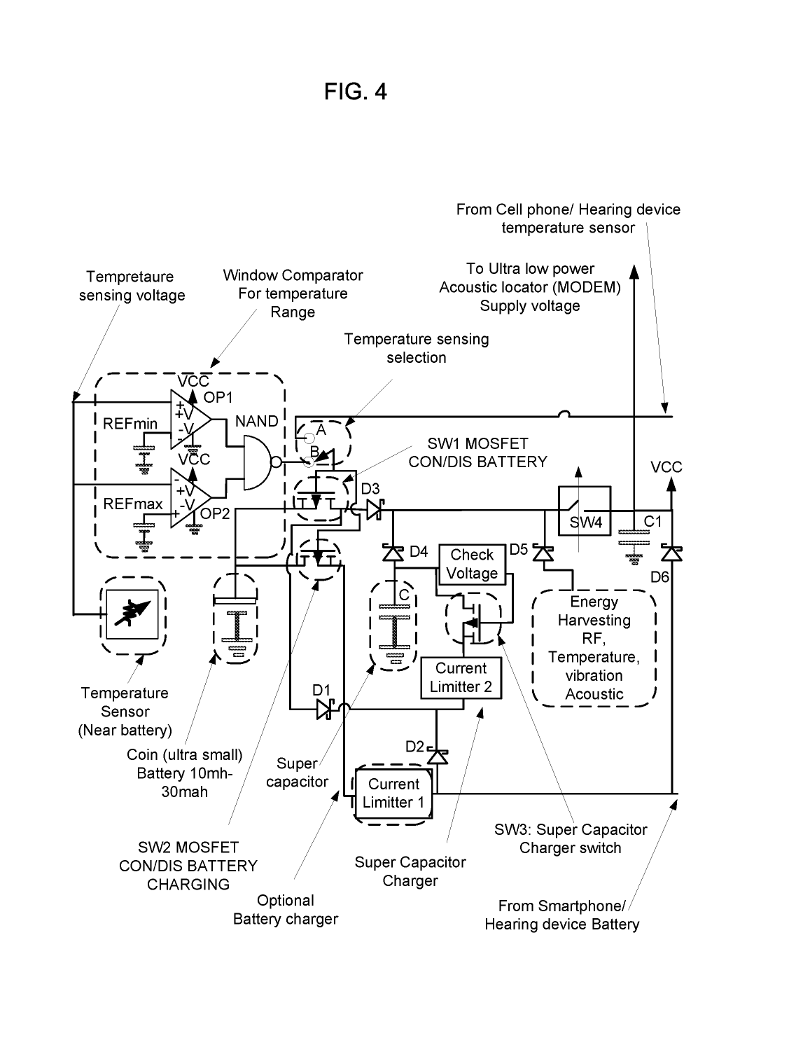

FIG. 4 is a simplified block-diagram of an energy system of a locator device such as the locator of in FIG. 1A, according to one exemplary embodiment.

As described before, the energy may come from the following options:

Option 1: Battery Only

In this case, for a safe operation, a temperature sensor may be required, which may be connected to a comparator having a window for a safe temperature range. However, it is preferable to have a super-capacitor in addition to the battery, so whenever the temperature is out of range (i.e.

temperature_sensing_voltage>REF_max, or

temperature_sensing_voltage<REF_min,

the NAND gate may output a HIGH and SW1 may disconnect the battery. Since it is safer to use a super-capacitor in extreme temperature ranges, it is preferable to have a super-capacitor generating the supply voltage at this case, while still allowing operation of the acoustic locator.

Option 2: Battery and Super-Capacitor

In this case, the supply voltage comes from the summation of the voltages using the Shotkky diodes D3 and D4. The super-capacitor in normal temperature ranges, is charging from the battery via SW1 and a current limiter 2 and SW3. Charging via SW1 is required since we can not use the battery at extreme, or out of range temperatures. D1 is a summation voltage from the local acoustic locator battery and the cell phone/hearing device battery. The voltage summation is done via D1, and D2. A current limiter is needed to charge the super-capacitor with a constant current, whenever the limit voltage of the ultra capacitor reached. This is done by “check voltage”, possibly implemented using a voltage comparator, which normally outputs a LOW and causes SW3 to be closed, and to pass the charging current into the super-capacitor. C1 typically of 1 uF-100 uF capacitor is needed, for reducing the voltage spikes, during periods when the battery's SW1 is turned off.

Option 3: Battery, Super-Capacitor and Host Battery

This option gives the acoustic locator 3 sources of energy. The added source is a host battery of the smartphone's/Bluetooth headsets hearing device/device battery. When an optional SW4 exists, that check for the existence of a smartphone's battery 113 (or a headsets battery 214), SW4 may disconnect all other sources i.e., the super-capacitor and the local small coin battery. The battery may still be charged via the current limiter 1, and SW2. If the temperature is in the safe range, and still charging of the super-capacitor continues via the smartphone's battery via a summation through D1, and D2, the charging of the super-capacitor is done via a current limiter 2. For a constant current charging, SW3 is turned off whenever the voltage on the super-capacitor C reaches the required voltage. This is checked using the check voltage box.

For all options above, a harvested energy source may further be added. All the voltages are summed to the anode called VCC via D3, D4, D5 and D6.

The temperature range checking, may be taken from a smartphone/tablet/Headsets device's temperature sensor. This way we can have two types of signals. First a digital signal which indicates that the temperature range is OK by outputting a “LOW” voltage value. Although the circuit has been designed using a P-channel MOSFET for the SW1, it may be designed with an N Channel MOSFET, and in this case an OK temperature range, may be indicated by a HIGH voltage. Second option may be using an analog value to indicate the temperature. In this case, we still need the temperature window comparator which is built using OP1 for a minimum value, and OP2 for checking the maximum value, and a NAND gate. If the temperature level is within REFmin and REFmax then OP1 may generate “1”—HIGH, and OP2 may generate “1” HIGH, and the output of the NAND may be “0” or LOW. This may cause SW1 to be closed, in order to allow connection of the battery to the circuit for regular operation, or for charging of the super-capacitor.

If the temperature indication is taken from the smartphone's own sensor, then the gate of SW1 MOSFET may be connected to node A of the temperature sensing selection of FIG. 4. If the temperature sensing is taken from the temperature sensor located near the battery, then the gate of SW MOSFET may be connected to node B of the temperature sensing selection.

In all options, the battery may be re-chargeable. In this case, the charging circuit for the local battery 118 draws power from the smartphone's battery 113 (or headset's battery 214), via current limiter 1 and SW2. In cases where the battery is not rechargeable, the charging circuit of the battery does not exist, and only the super-capacitor charging circuit exists.

Ultra-Low-Power Acoustic Transceiver Protocol:

In order to allow an ultra-low-power consumption for the acoustic transceiver we need to consider hardware and software changes as well. For the hardware side, extremely low power microphone and marker/beacon/preamble detection circuits were designed. With regard to the activation of the ultra-low-power acoustic transceiver, a novel ultra-low-power protocol was designed, as follows:

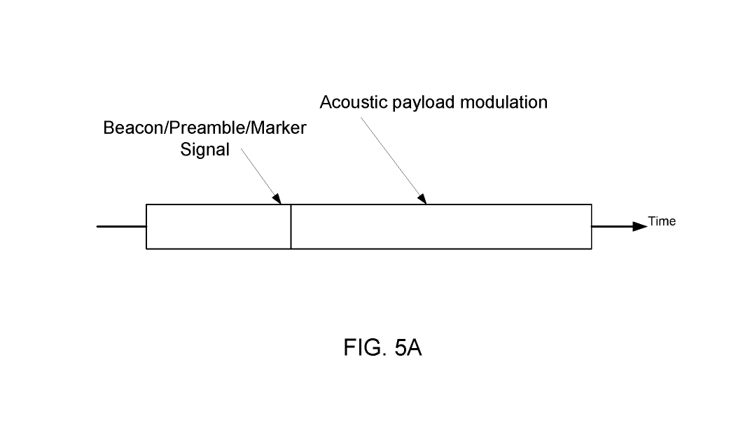

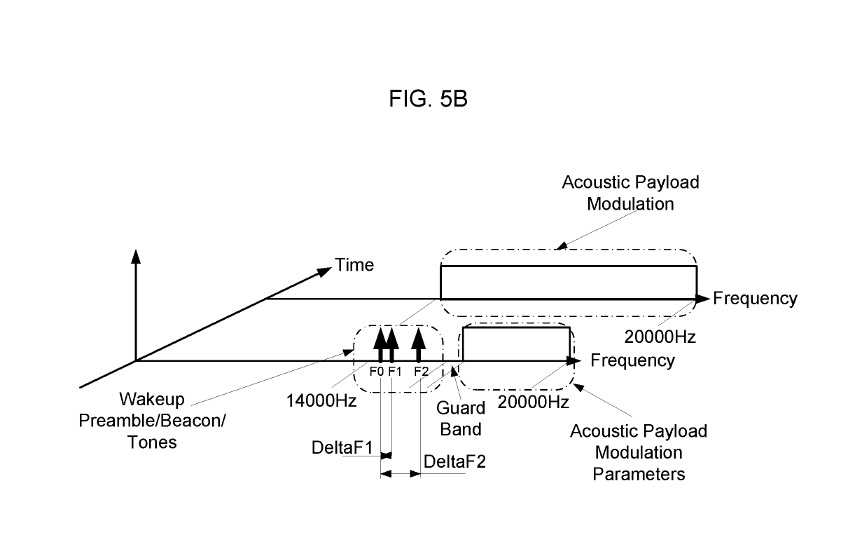

FIG. 5A is a simplified block-diagram of an ultra-low-power protocol, according to one exemplary embodiment.

FIG. 5B is a simplified diagram of an ultra-low-power protocol in time-frequency domain, according to one exemplary embodiment.

FIGS. 5A and 5B describe the ultra-low-power acoustic protocol working in the range of 14000 Hz-20000 Hz. The reasons for working in that range, is first the acoustic signals transmitted in this range may usually not be heard by a human, and the amount of acoustic noise in this area is relatively low. In addition, this range of frequency is supported by most PCs, tablets, smartphones, and hence the acoustic signal described by FIG. 5A may be generated and transmitted using the speakers. Acoustic transmission in a PC, smartphone or tablet, may easily be accomplished by installing designated program or application, or by using a designated web site.

The ultra-low-power protocol is divided into two basic parts. First is the Beacon/Preamble/marker/tones signal, and second is a payload signal. The first is a signal that may easily be detected with an ultra-low-power microphone and an energy detector. The marker signal, shown in FIG. 5B which is called a WakeUP signal, is typically comprised of multiple tones (at least one tone). The reason for the multiple tones is that the modulation based frequency difference between the tones is used. Due to the High Doppler effect of the acoustic channel, the message is encoded by x=F1−F0 and y=F2−F0.

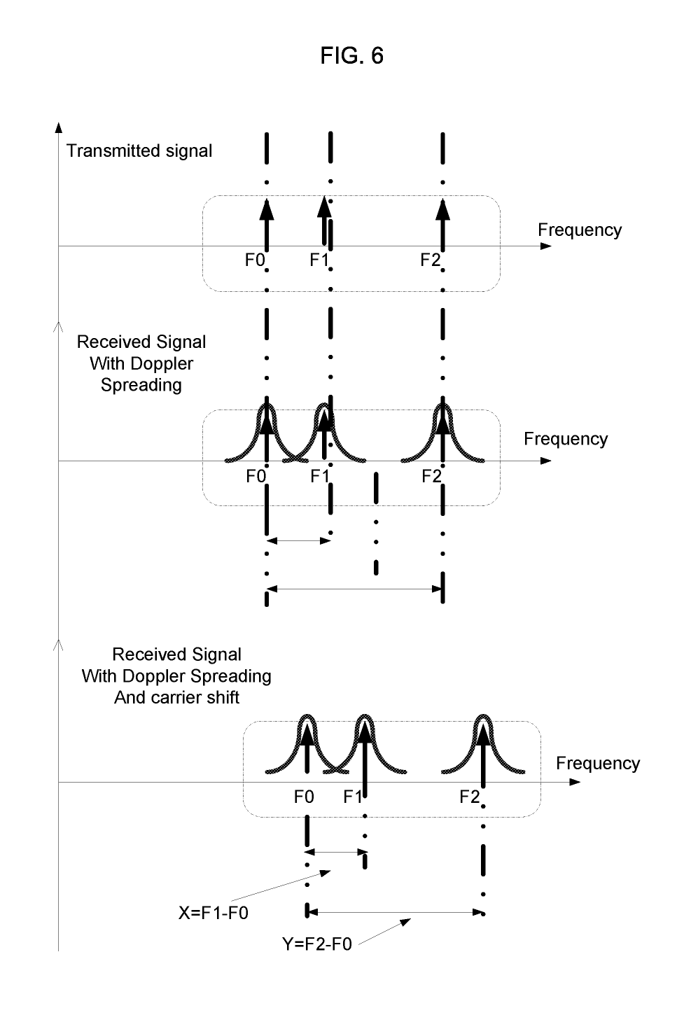

The robustness of the WakeUP signal is shown by FIG. 6:

FIG. 6 is a simplified illustration of a WakeUp signal modulation, according to one exemplary embodiment.

The second and third waveform diagram shows the received wakeUp signal after Doppler at the receiver input. On the 2nd waveform diagram, and on the third waveform diagram, the received signal with Doppler spreads with a carrier shift. We can see that in both cases a window based filter may generate the max value and picks, from which we can easily extract the x=F1−F0 and y=F2−F0.

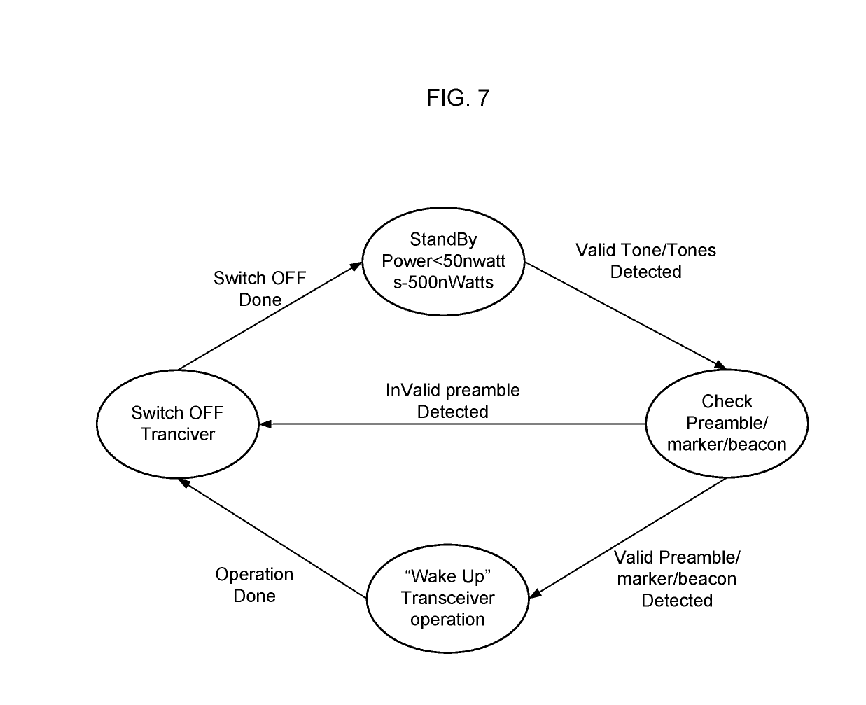

FIG. 7 is a simplified illustration of a state machine of the ultra-low-power acoustic transceiver, according to one exemplary embodiment.

At first, the receiver is in standby. At that time, only an ultra-low-power microphone is working with a few nano-amperes is active, and an ultra-low-power active filter and an ultra-low-power envelope and energy detection circuit are active.

This is the first state of the state machine, which at that time the ultra-low-power acoustic transceiver is in “StandBy” mode. When a tone or tones appears in some band as shown by FIG. 5, they are marked as “WakeUp” and detected, then and the state machine goes to “Check Preamble”. Note that the modulation parameters are separated by a guard band in the frequency domain. This is done in order to avoid a Doppler leakage from the Tones F0, F1, and F2 to the modulation parameter portion. The preamble which may turn on the ultra-low-power acoustic receiver, is designated by some messaging using the differences between multiple tones as shown in FIG. 5. In FIG. 5 we see a case where there are 3 tones used at the time when the receiver is waked up to check the preamble message. Moreover, this part can also be implemented in designated HW. In any case, this wake up scenario happens only when there is a detection of energy at the designated acoustic band. On the 2nd state, a processor may be waked up, to quickly check the validity of the tones combination. If the tones combination is valid, the acoustic transceiver is waked up. Then the acoustic transceiver typically first demodulate the “modulation parameters”, and then demodulate the “acoustic payload modulation”.

The acoustic payload modulation can hold a command, while the designated unique ID (address) is typically comprised of the user telephone number and a PIN/STRING code. The acoustic locator may receive at that time the unique ID, and may compare it with its local programmed unique ID. If they are the same, then the processor may generate a beep using the local loud speaker. Another option may also employ a strength based finding algorithm, which may be used by forcing the acoustic locater to send some tones which may be picked up by a tablet/or another smartphone. An application may then calculate the distance and help the user or direct him to the place where the lost smartphone/tablet/Headsets hearing device/or any other lost device is located.

Ultra-Low-Power Acoustic Receiver Circuits

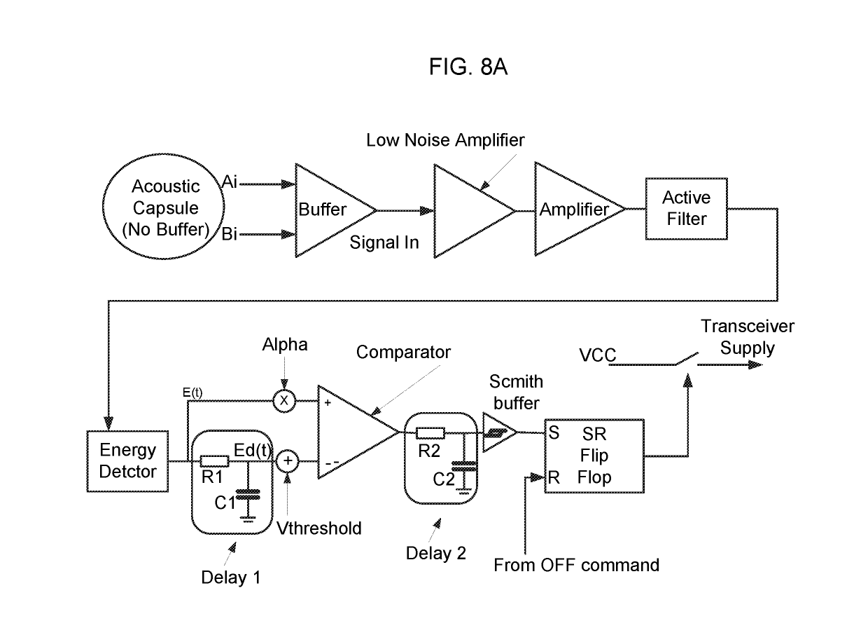

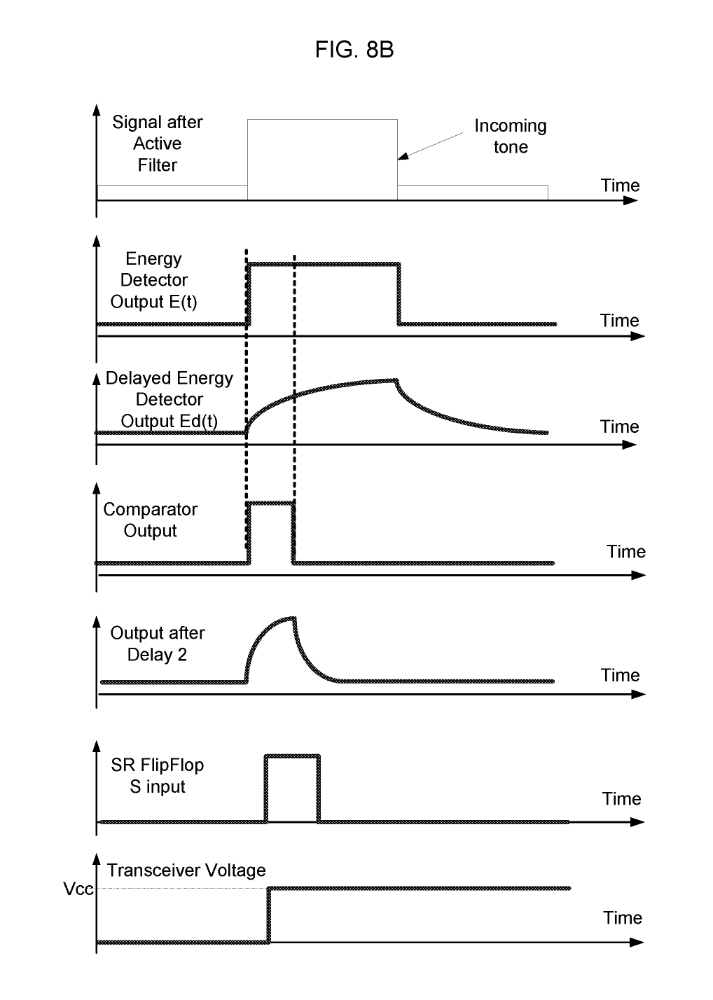

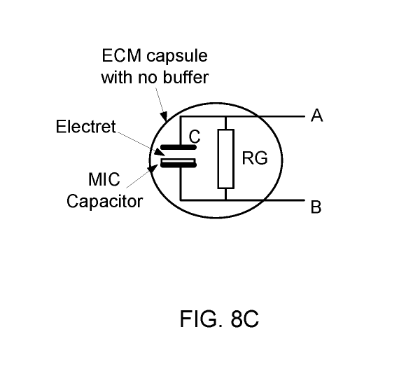

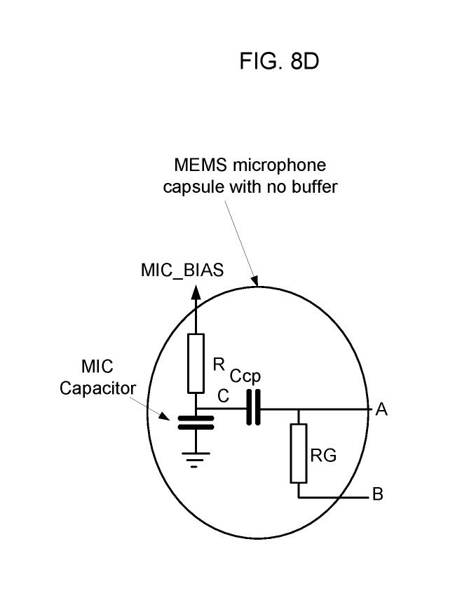

FIG. 8A is a simplified block-diagram of an ultra-low-power signal detection circuit, according to one exemplary embodiment. FIG. 8A is an example of a standby detector.

FIG. 8B is a simplified diagram of an ultra-low-power standby signal detection waveform, according to one exemplary embodiment.

FIG. 8C is a simplified diagram of an Electret condenser microphone with no buffer, according to one exemplary embodiment.

FIG. 8D is a simplified diagram of a MEMS microphone with no buffer, according to one exemplary embodiment.

Valid tone and/or tones detection.

This circuit of FIG. 7.1 may have a microphone signal at its input. The microphone may be based on a Micro Electronic Mechanical Systems (MEMS) microphone as capacitor as in FIG. 8D, or as an electrets condenser microphone as in FIG. 8C. This MEMS as an input signal. The MEMS microphone, or the electrets condenser microphone, both are based on capacitance variations. Also, both are needed to be connected to a buffer. In the disclosed application an ultra-low-power buffer/amplifier for the microphone is describe. The second element for FIG. 8A is the low noise amplifier (LNA) which is needed to boost the signal in order to allow working with high input noise and with ultra-low-power active filters. FIG. 8B shows the first waveform of the output of the active filter, which shows a jump in the signal level where valid tone/tones have been received. Then the output of the active filter of FIG. 8A goes to an energy detector/envelope detector, for the purpose of detecting this jump. The current energy level/envelope is compared against the delayed ones—delay 1 of FIG. 8A, and the fourth waveform of FIG. 8B shows the detection pulse, which is the output of the comparator of FIG. 8A. The detection pulse is further passed through a second delay of FIG. 8A, which insures that the detection pulse is not a false alarm spike. Later it passed to a Schmitt trigger buffer, in which its output is shown on the sixth waveform of FIG. 8B. The detection pulse from the Schmitt trigger is used to SET the Q output of the SR flip flop to “1”, causing the VCC supply switch of FIG. 8A to be closed.

When the VCC supply voltage to the acoustic transceiver is closed, a second circuit is turned on to check the validity of the tone/tones combination. This is shown in the second state of FIG. 7. This second circuit may be implemented by a dedicated low power HW or by a processor with dedicated SW algorithm.

Valid tone/tones detection HW building blocks, and microphone ultra-low-power buffer.

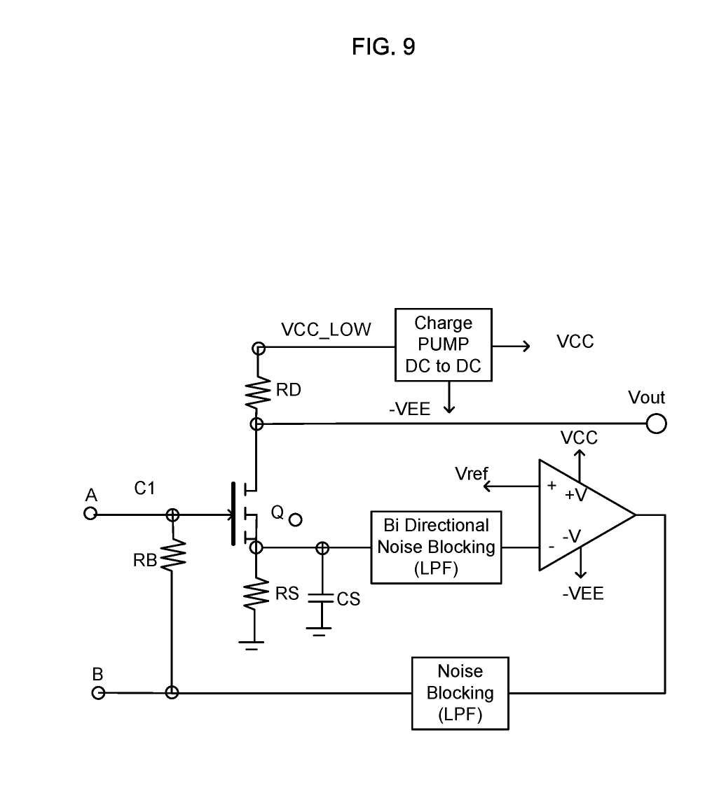

FIG. 9 is a simplified electric diagram of a MOSFET microphone buffer circuitry, according to one exemplary embodiment.

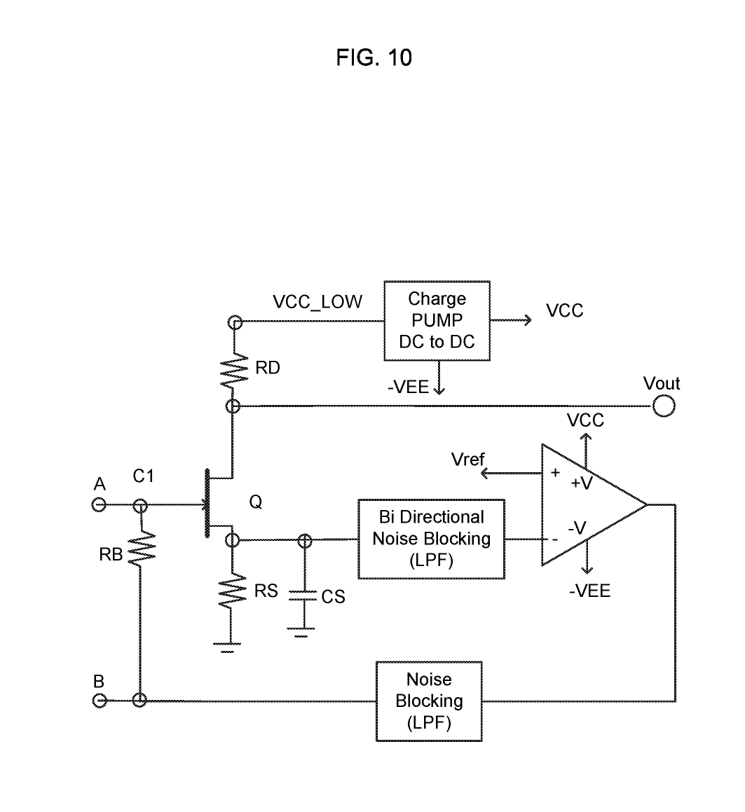

FIG. 10 is a simplified electric diagram of a JFET microphone buffer circuitry, according to one exemplary embodiment.

The microphone buffer circuit of FIG. 9 and/or FIG. 10 may be connected to an Electret microphone such as shown and described with reference to FIG. 8C, or to a MEMS microphone such as shown and described with reference to FIG. 8D. The microphone may be connected to pins A, and B. The circuitry of FIG. 9 uses a MOSFET, and the circuitry of FIG. 10 uses a JFET:

FIG. 10: Microphone buffer connected to FIG. 8C or FIG. 8D microphones to pins A, and B based on JFET

The microphone buffers of FIGS. 9, and 10 are suitable for electret condenser microphones (ECM) and for MESM microphones. Both of the buffers of FIGS. 9, and 10, work on saturation region. This region insures amplification. Both buffers work with extremely low VCC, which is specified in both Figures by VCC_LOW. VCC_LOW can be such as 20 mv. The transistors are selected such that IDSS of each transistor is high, so it would be possible to decrease significantly the Id.

Basically the SNR is given by Eq. 1:

$$SNR = \frac{{g}_{m}^{2} {R}_{D}^{2} 〈 {V}_{IN}^{2} 〉}{4 KT ( \frac{2}{3} ) {g}_{m} Δ {fR}_{D }^{2}} = {g}_{m} = \frac{〈 {V}_{IN}^{2} 〉}{4 KT ( \frac{2}{3} ) Δ f} = {g}_{m} = - \frac{2}{{V}_{X}} \sqrt{{I}_{D} {I}_{DSS}} \frac{〈 {V}_{IN}^{2} 〉}{4 KT ( \frac{2}{3} ) Δ f} \qquad Eq . 1$$

Vin is the input voltage at nodes A, and B. The IDSS of each of the JFET of FIG. 10 or MOSFET of FIG. 9, is high (e.g. 100 ma). Compared to a regular IDSS of JFET ECM buffer such as JFET type TF202 with 300 ua=0.3 ma, then in order to work at the same SNR, we can decrease the ID (normal Id) of 300 ua by 300. This means that Id=1 ua. It is easy to show now that VCC LOW may be as low as 20 mv in order to insure the operation of MOSFET of FIG. 9, and the JFET of FIG. 10 in saturation. Therefore, the power consumption of the buffer shown in FIGS. 9, and 10, is about 20 nwatts. Since we use efficient DC 2 DC charge pump, then the power consumed by the microphone buffer is about 20 nwatts. For the DC 2 DC charge pump we use a 32 kHz oscillator, which may consume about 50-100 nwatts. So in total, the microphone buffer may consume about 90 nwats.

The buffers of FIGS. 9 and 10 may use OP amplifier to set the ID according to a predefined Vref, such that Id=Vref/RS. Then the OP amplifier may change its output and may supply Vgs for the controlling of the Id. The OP amplifier may be implemented for using an extremely low power, since it would need to work with a low gain band width which is near DC. Therefore, such OP amplifier suffers from high input and output noises. These noise sources are eliminated using the Bi directional noise blocking filter. This filter in one sense passes the current to voltage conversion of a first input of the OP amplifier, and on the other side may block the input noise on the “−” pin to the active element JFET of FIG. 10 or the MOSFET of FIG. 9.

The noise from the output is blocked using a noise blocking filter. Both filters may be passive low-pass filters.

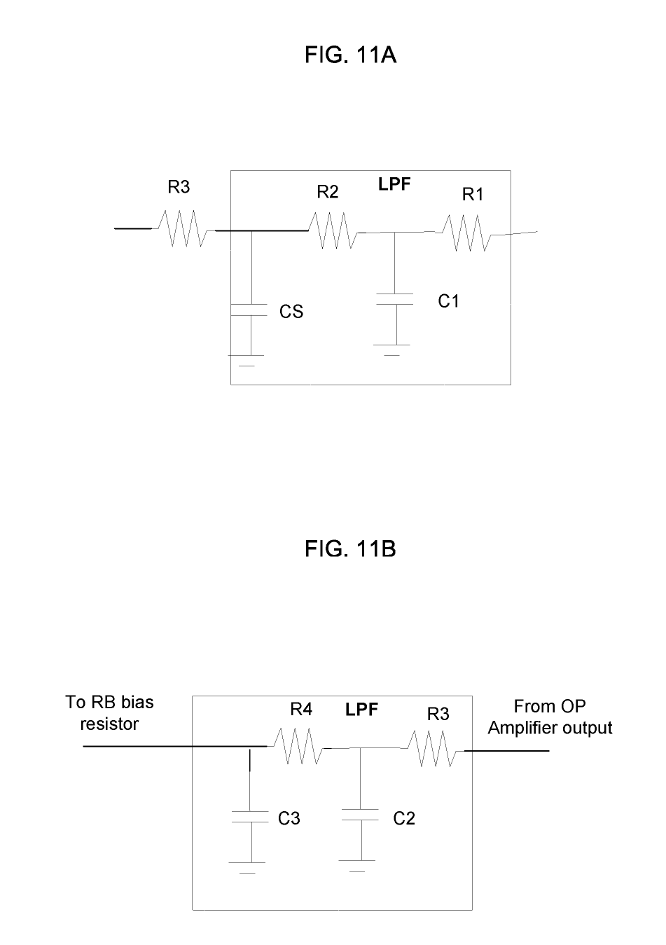

FIG. 11A is a simplified electric diagram of a bidirectional noise blocking filter (LPF), according to one exemplary embodiment.

FIG. 11B is a simplified electric diagram of a noise blocking filter (LPF) from the output of the OP amplifier to RB, according to one exemplary embodiment.

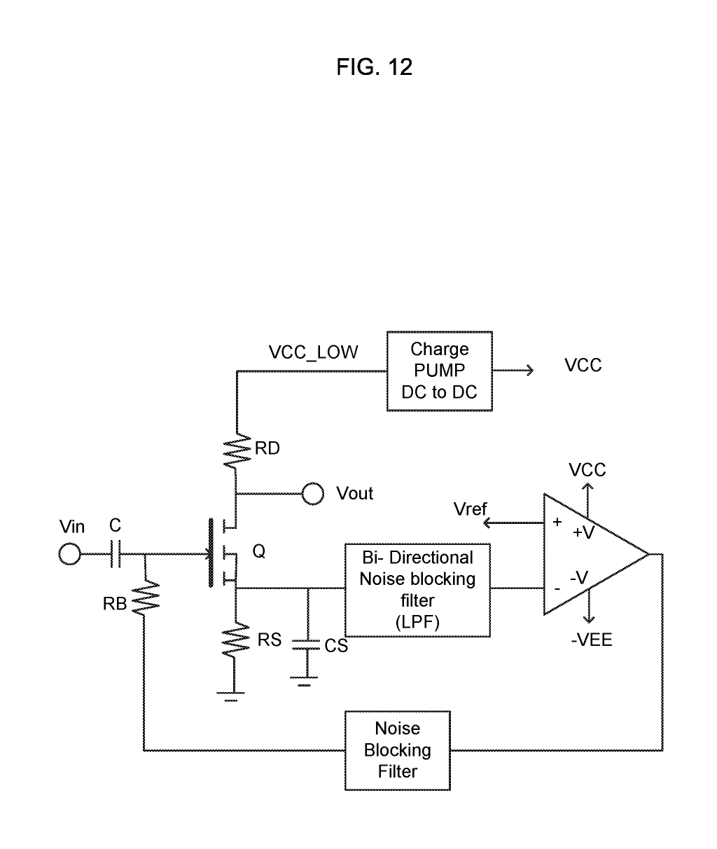

FIG. 12 is a simplified electric diagram of a low-noise-amplifier (LNA) using MOSFET with LPF filters to reject noise from an op amplifier, according to one exemplary embodiment.

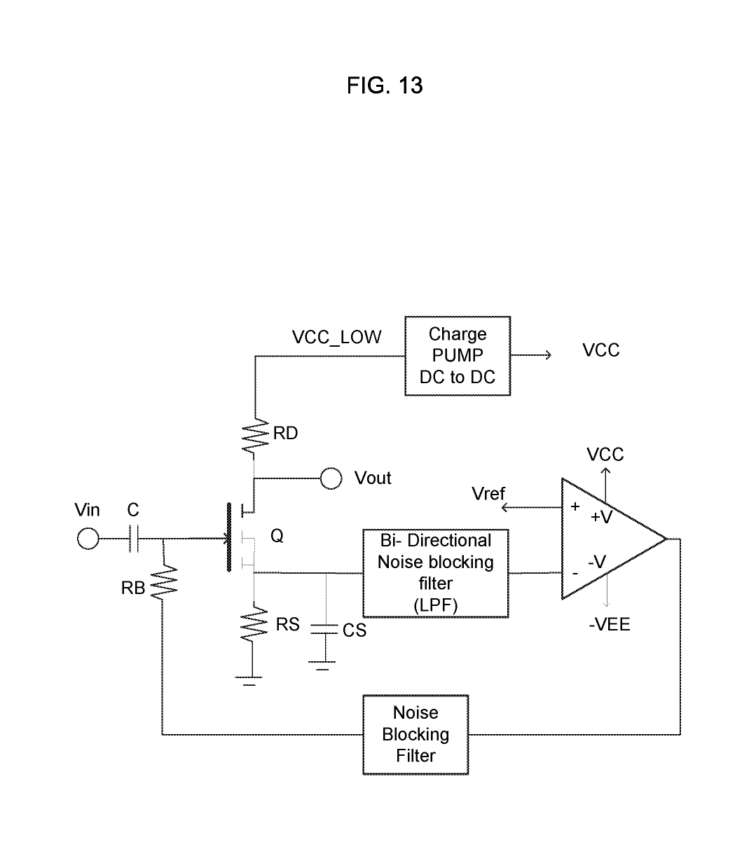

FIG. 13 is a simplified electric diagram of a low-noise-amplifier (LNA) using JFET with LPF filters to reject noise from an op amplifier, according to one exemplary embodiment.

Both circuits are based on having the JFET or the MOSFET in a saturation mode, where we get amplification. We choose to have wide JFET/MOSFET for getting higher IDSS, such that ID may be reduced significantly. This is done using an OP amplifier which is used as a control feedback amplifier. This amplifier sets the Id current to a predefined current, such that Id=Vref/RS current to voltage from the FET source pin is passed to the OP amplifier to its “−” pin. A Vref is connected to its “+” pin. Whenever the + is greater than the −, the OP may increase its voltage in a positive direction (decreasing the negative Vgs). This may increase the Id.

The SNR is described by Eq. 1.

As shown by Eq. 1, having a wide FET may allow having the LNA in low Id. Moreover, in order to be in a saturation mode, it is clear that V_{DS}>V_{GS}−V_{X} where V_{X} is either V_{T} (for MOSFET) or V_{P} (for JFET).

Eqs. 2 and 3 describe the Id current for MOSFET and JFET respectively:

$$\begin{matrix}{I}_{D} = \frac{{WC}_{ox} μ}{L} {( {V}_{GS} - {V}_{T} )}^{2} = \frac{{WC}_{ox} μ}{{LV}_{T}^{2}} {( 1 - \frac{{V}_{GS}}{{V}_{T}} )}^{2} == {{I}_{DSS} ( 1 - \frac{{V}_{GS}}{{V}_{T}} )}^{2} ⇒ {g}_{m} = - \frac{2}{{V}_{T}} \sqrt{{I}_{D} {I}_{DSS}} & Eq . 2 \\ {I}_{D} = {{I}_{DSS} ( 1 - \frac{{V}_{GS}}{{V}_{P}} )}^{2} ⇒ {g}_{m} = - \frac{2}{{V}_{P}} \sqrt{{I}_{D} {I}_{DSS}} \\ Clearly , & Eq . 3 \\ {V}_{GS} - {V}_{X} = \sqrt{\frac{{I}_{D}}{{I}_{DSS}}} \vert {V}_{X} \vert & Eq . 4\end{matrix}$$

Approximately, we can assume that:

$$\begin{matrix}VCC\_LOW \approx 1.1 [ {I}_{D} ( {R}_{S} + {R}_{D} ) + \sqrt{\frac{{I}_{D}}{{I}_{DSS }}} \vert {V}_{X} \vert ] and hence & Eq . 5 \\ Power \approx 1.1 [ {I}_{D}^{2} ( {R}_{S} + {R}_{D} ) + {I}_{D} \sqrt{\frac{{I}_{D}}{{I}_{DSS}}} \vert {V}_{X} \vert ] & Eq . 6\end{matrix}$$

on the other hand the gain is:

$$Gain = {R}_{D} {g}_{m} = - \frac{2 {R}_{D}}{{V}_{X}} \sqrt{{I}_{D} {I}_{DSS}} \qquad Eq . 7$$

to get some gain we must have:

$$\begin{matrix} {I}_{D} = \frac{1}{{I}_{DSS}} {( \frac{Gain \cdot {V}_{X}}{2 {R}_{D}} )}^{2} or & Eq . 8 \\ Power \approx 1.1 [ \frac{1}{{I}_{DSS}^{2}} {( \frac{Gain \cdot {V}_{X}}{2 {R}_{D}} )}^{4} ( {R}_{S} + {R}_{D} ) + \frac{1}{{I}_{DSS}} {( \frac{Gain \cdot {V}_{X}}{2 {R}_{D}} )}^{2} \sqrt{\frac{\frac{1}{{I}_{DSS }} {( \frac{Gain \cdot {V}_{X}}{2 {R}_{D}} )}^{2}}{{I}_{DSS}}} \vert {V}_{X} \vert ] = 1.1 [ \frac{1}{{I}_{DSS}^{2}} {( \frac{Gain \cdot {V}_{X}}{2 {R}_{D}} )}^{4} ( {R}_{S} + {R}_{D} ) + \frac{1}{{I}_{DSS}^{2}} {( \frac{Gain \cdot {V}_{X}}{2 {R}_{D}} )}^{3} \vert {V}_{X} \vert ] = 1.1 \frac{1}{{I}_{DSS}^{2}} {( \frac{Gain \cdot {V}_{X}}{2 {R}_{D}} )}^{3} [ ( \frac{Gain \cdot {V}_{X}}{2} ) ( 1 + \frac{{R}_{S}}{{R}_{D} } ) + {V}_{X} ] & Eq . 9\end{matrix}$$

As seen from Eq. 9, for larger gains and Rs=−Rd we have:

$$Power = 1.1 \frac{1}{{I}_{DSS}^{2}} {( \frac{Gain \cdot {V}_{X}}{2 {R}_{D}} )}^{3} Gain \cdot {V}_{X} \qquad Eq . 9 )$$

putting back Eq. 7 for Rd we get:

$$Power = 1.1 \frac{1}{{I}_{DSS}^{2}} {( \sqrt{{I}_{D} {I}_{DSS }} )}^{3} Gain \cdot {V}_{X} = 1.1 {I}_{D} Gain \cdot {V}_{X} \sqrt{\frac{{I}_{D}}{{I}_{DSS}}} \qquad Eq . 10 )$$

For example, assuming that the FET is working with noise of about 17 nv/sqrt(Hz). This is about FET with IDSS=0.5 ma, and Id=Idss. Now, let's assume that we take a FET with Idss=100 ma. This would mean that in order to work with the same noise, we can have the Id=Previous Id/200=2.5 ua.

So we get:

$$Power == 1.1 {I}_{D} Gain \cdot {V}_{X} \sqrt{\frac{{I}_{D}}{{I}_{DSS }}} = 1.1 \cdot 2.5 ua \cdot 10 \cdot 1 v \frac{1}{200} \approx 250 nwatts \qquad Eq . 11$$

If we take even a larger FET with Idss=200 ma, Id=1.25 ua and:

$$Power == 1.1 {I}_{D} Gain \cdot {V}_{X} \sqrt{\frac{{I}_{D}}{{I}_{DSS }}} = 1.1 \cdot 1.25 ua \cdot 10 \cdot 1 v \frac{1}{400} \approx 62.5 nwatts \qquad Eq . 12$$

then we get power consumption of 62.5 nwatts for the LNA.

The Bi-directional noise blocking filter and the second noise blocking filter, are used as before to block the noise form the OP amplifier which works with a low Gain Band Width (since it is just used for the DC operating point). In this case, the OP amplifier may consume extremely low power as low as 10 nwatts, but may have a high noise at its inputs and output as well. Therefore, a LPF noise blocking filter is used. A realization of the bi-directional noise blocking filter and the second noise blocking filter is described by FIG. 11.

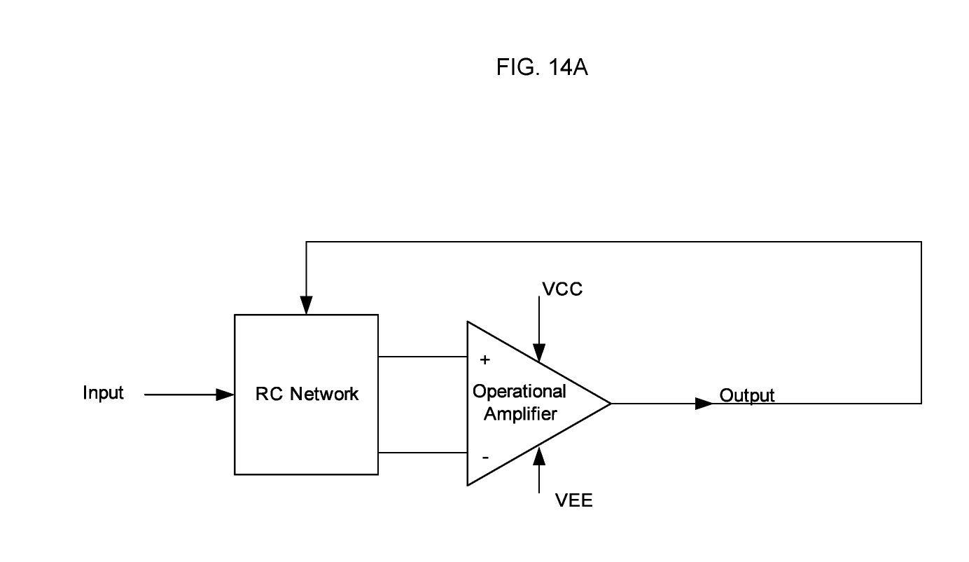

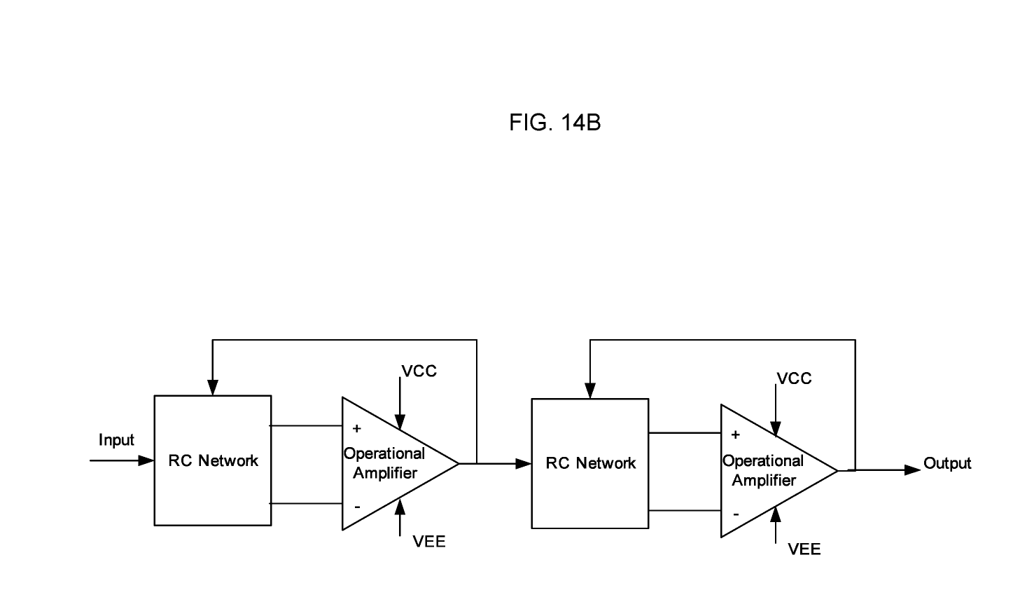

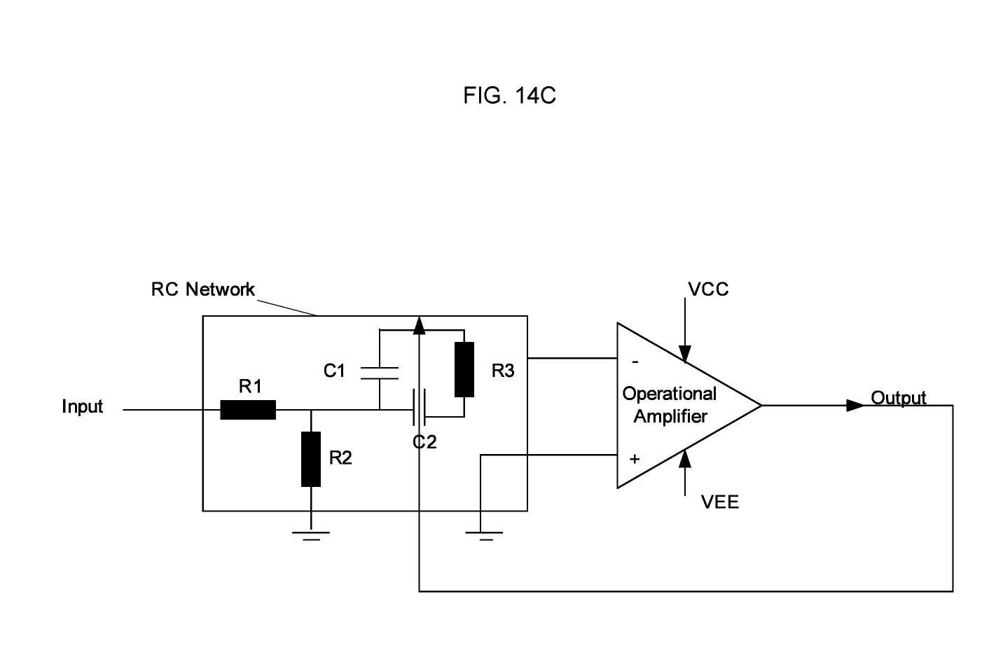

FIG. 14A is a simplified block-diagram of an active filter, according to one exemplary embodiment.

FIG. 14B is a simplified block-diagram of a two-stage active filter, according to one exemplary embodiment.

FIG. 14C is a simplified block-diagram of a 2nd Order Band Pass Filter, according to one exemplary embodiment.

The active filter of FIG. 14A, is based on an op amplifier, and a resistor capacitor network designated as RC network. In order to realize a high order implementation, two or more stages of FIG. 14A are connected in serial, and the RC values are designed to implement the desired response such as Butterworth, Chebbycheff, elliptic, etc. filter.

FIG. 14C describes one stage of band pass filter with 2nd order.

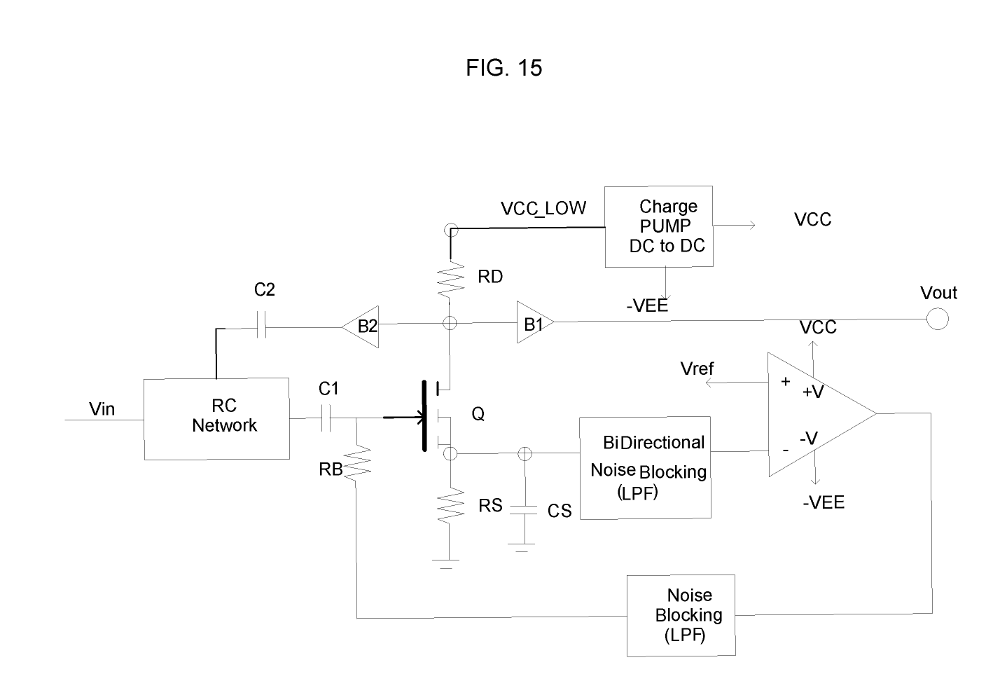

FIG. 15 is a simplified block-diagram of a single-stage, ultra-low-power, active filter using MOSFET with noise blocking filters, according to one exemplary embodiment.

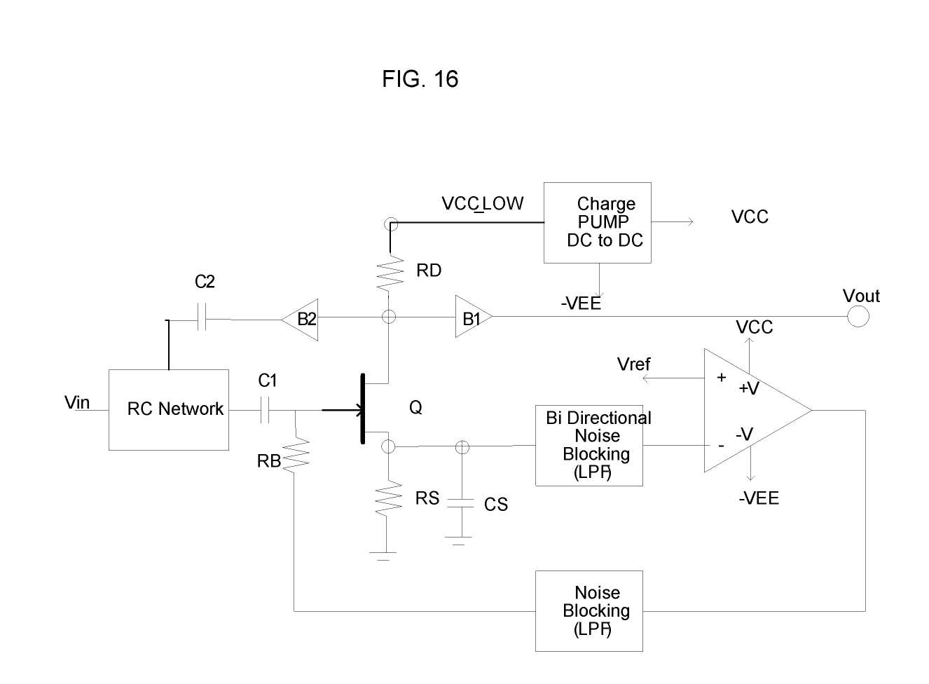

FIG. 16 is a simplified block-diagram of a single-stage, ultra-low-power, active filter using JFET with noise blocking filters, according to one exemplary embodiment.

B1 and B2 of FIGS. 15, and 16 are buffers, which may be implemented using a wire or a source follower buffer.

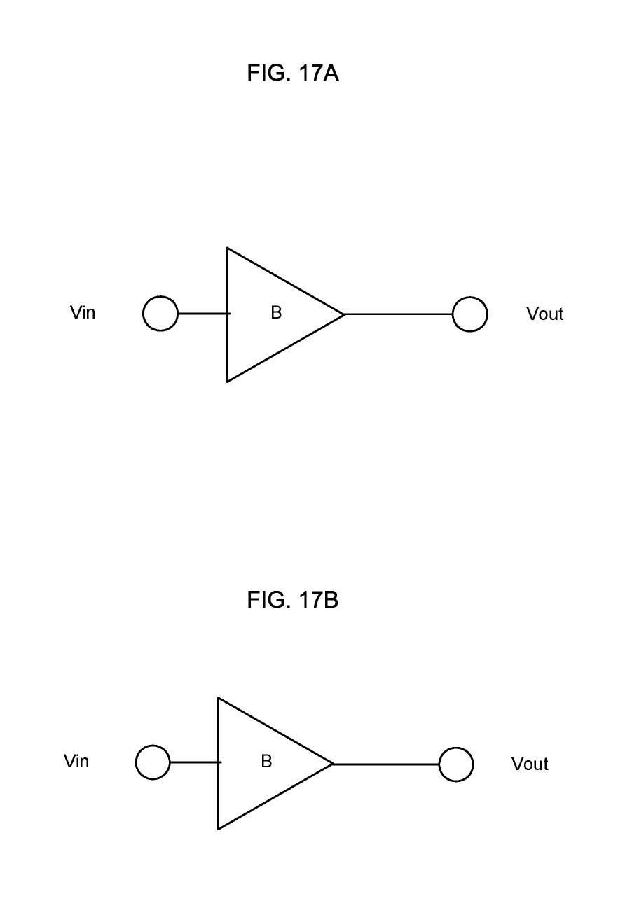

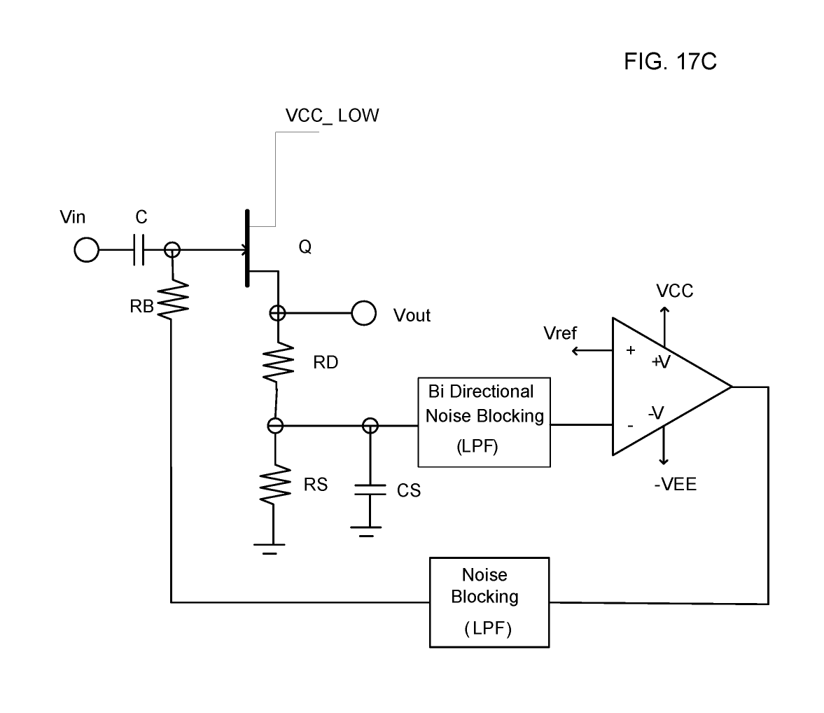

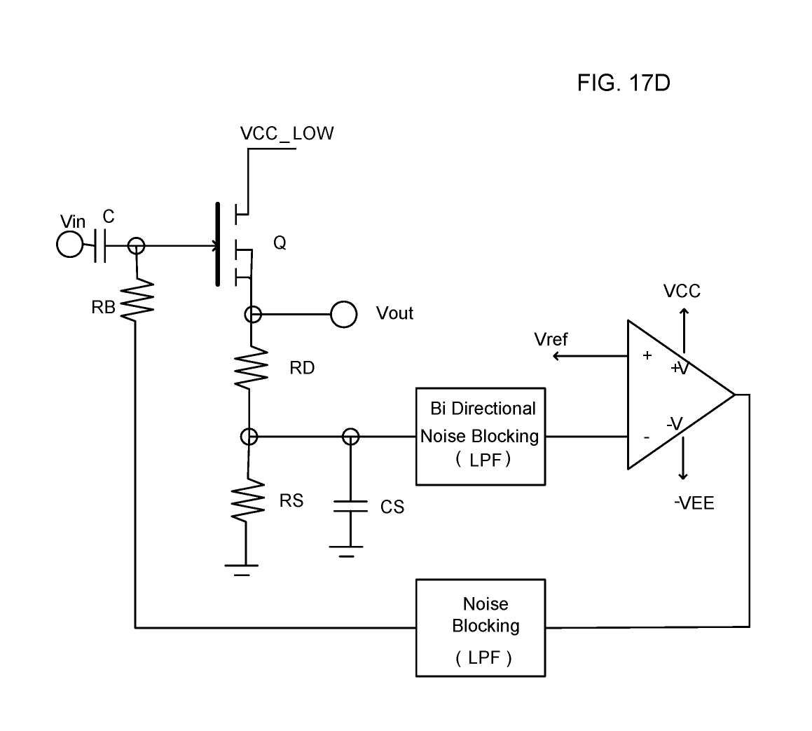

FIG. 17A is a simplified symbol of an ultra-low-power voltage buffer, according to one exemplary embodiment.

FIG. 17B is a simplified diagram of a wire implementation of the ultra-low-power voltage buffer of FIG. 17A, according to one exemplary embodiment.

FIG. 17C is a simplified diagram of a possible implementation of the ultra-low-power voltage buffer of FIG. 17A with JFET, according to one exemplary embodiment.

FIG. 17D is a simplified diagram of a possible implementation of the ultra-low-power voltage buffer of FIG. 17A with MOSFET, according to one exemplary embodiment.

FIGS. 17A-17D describes the B1, and B2 ultra-low-power implementation. Voltage Buffer implementations with noise blocking filters:

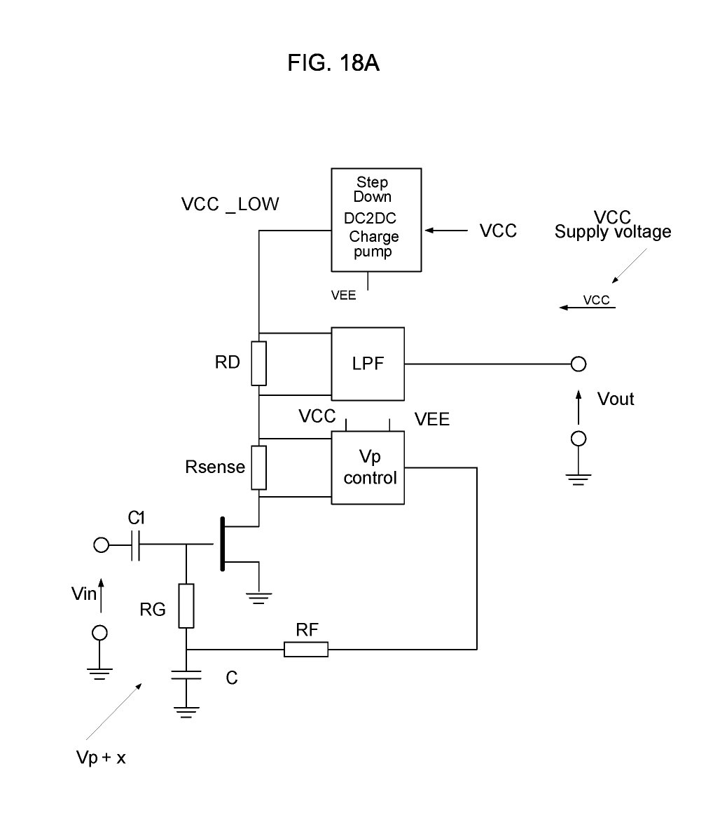

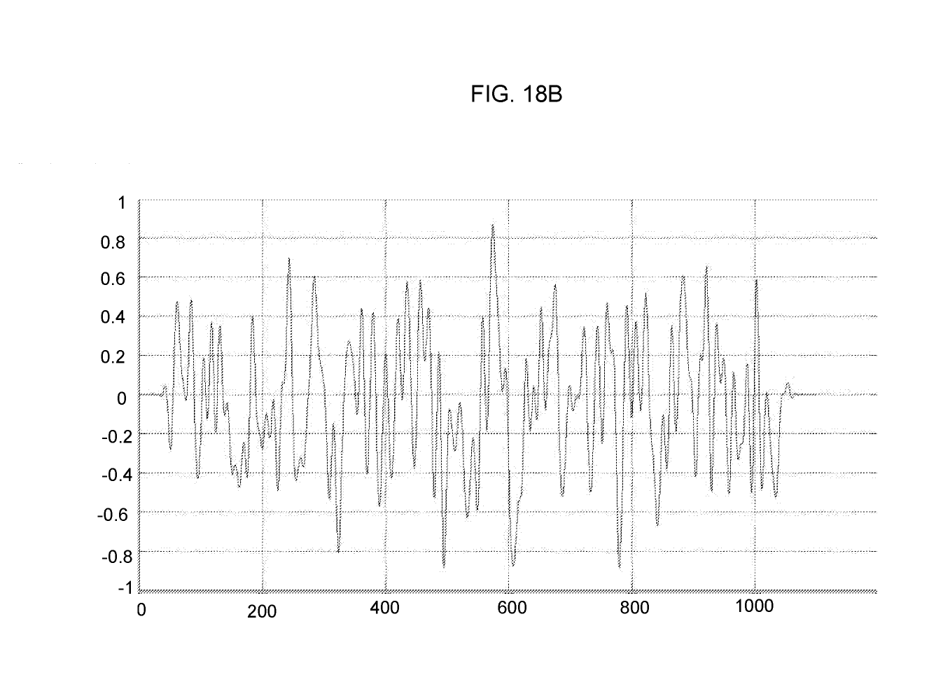

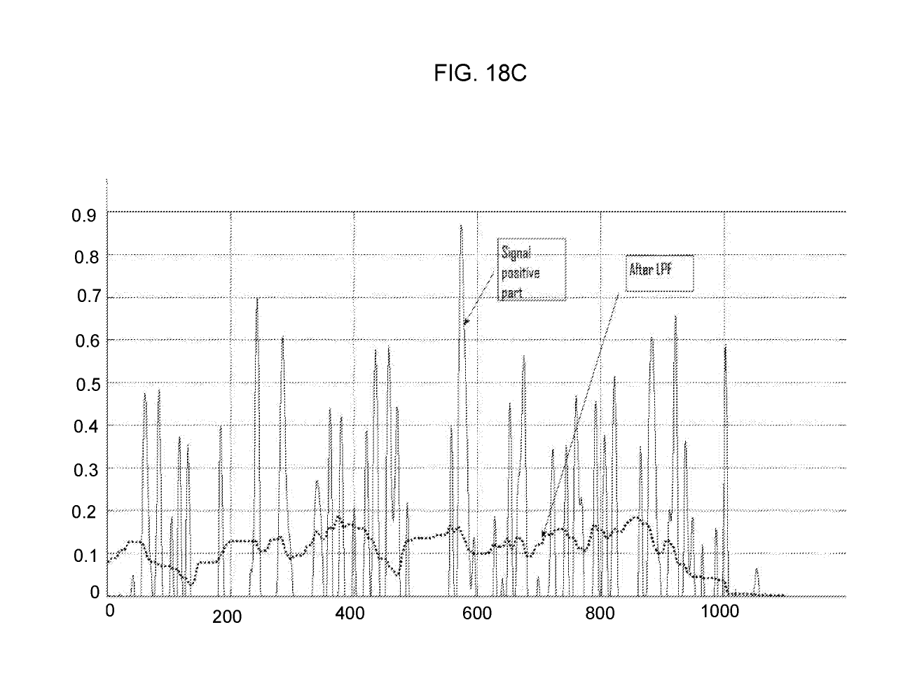

FIG. 18A is a simplified diagram of a of an envelope and/or energy detector, according to one exemplary embodiment.

FIG. 18B is a simplified illustration of an input signal, according to one exemplary embodiment.

FIG. 18C is a simplified illustration of an output signal on RD and output of LPF, according to one exemplary embodiment.

FIG. 18A describes the envelope/energy detector. This circuit is based on JFET, but may be implemented also with MOSFET. The circuit of FIG. 18A is typically normally in cutoff when there is no input signal. However, it may also be in extremely low conduction, in the saturation region.

$${I}_{D} = {{I}_{DSS} ( 1 - \frac{{V}_{GS}}{{V}_{P}} )}^{2} \qquad Eq . 13$$

Equation 13 describes the relation between V_{GS} and the transistor current.

As V_{GS}=V_{P}+x+Vᵢₙ where x is very small, then for x+Vᵢₙ≥0⇒Vᵢₙ≥−x the transistor may conduct. The resistors RD and Rsense are designed such that the transistor would be in saturation and then in this case Eq. 13 holds.

I_{D}=I_{DSS}(x+Vₜₕ)² and therefore the voltage on RD and Rsense would be: Eq. 14)

Vᵣₑₛᵢₛₜₒᵣₛ=(RD+Rsenses)I_{DSS}(x+V_{ib})² Eq. ¹⁵

This voltage is designed such that

V_{GS}−V_{P}=x+Vᵢₙ<V_{DS}=VCC_LOW−(RD+Rsenses)I_{DSS}(x+V_{ib})²

The circuit of FIG. 18A can generate the average value of the Vin positive part, with a Low Pass Filter (comprised by a passive filter having only resistors and capacitors).

FIG. 18B shows an example of an input signal. FIG. 18C shows two waveforms. The first one is a positive part of the signal, and the second one is the average (which indicates the energy detection).

The operation of the circuit of FIG. 18A is based on a feedback loop (typically working with extremely low Gain Band Width and hence consume extremely low power). This loop measures the Id current through a sense resistor Rsense, and through an RF charge or discharge capacitor C, such that when the loop stabilizes, there may be a voltage of Vp+x, and hence the current of Id would be set to I_{D}=I_{DSS}(x)².

The circuit also works with a very low power supply such as a few my (20 mv-50 mv) and with a low current such as 0.1 ua-1 lua. This is why the envelope detector having the control feedback loop, can consume about 70 nwatts (assuming the control feedback loop consumes about 20 nwatts).

The low voltage supply is generated typically with a step down DC 2 DC charge pump. This charge pump typically works with low frequency, such as 32 kHz-100 kHz, and which can reach an efficiency of 95%-98%.

In several cases, where the signal is low (such as in the range of nV), it is required to use relatively high capacitors for the bi-directional blocking filters, and for noise blocking filters and for CS. This is due to the fact that we wish to have a small total noise. For example, if we work on BW of 500 Hz, the sqrt(BW)=25 . For noise of 15 nv/sqrt*Hz, we would have a total noise of 0.375 uv. This means that the capacitors should be in the range of lOnano farad. These capacitor would then be external to the chip.

Hence the capacitor outside of the chip would be the capacitor of the microphone buffer LNA, and the amplifier. After getting an amplification of 100, we may be working with a noise floor of 37.6 uv. This may allow us to use pico farad range capacitors, to be implemented inside the chip.

Module Packing and Implementation

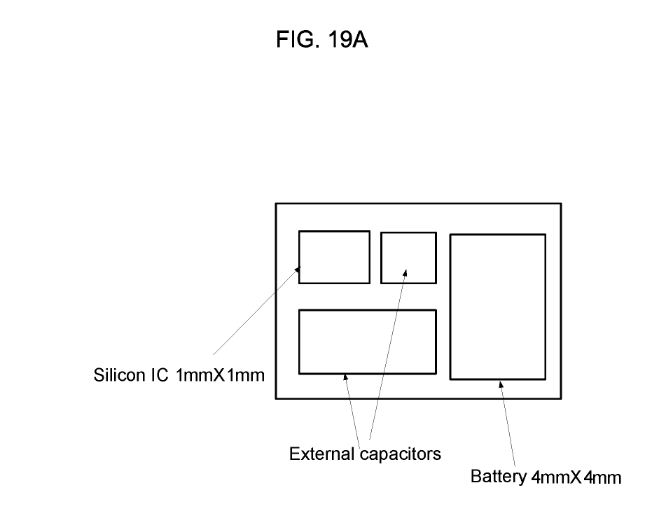

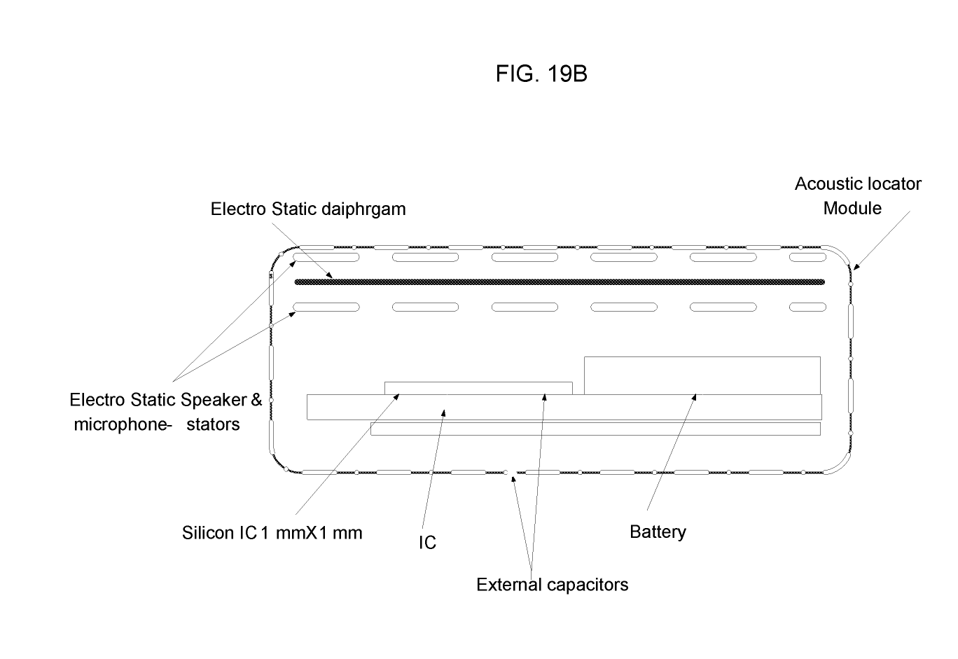

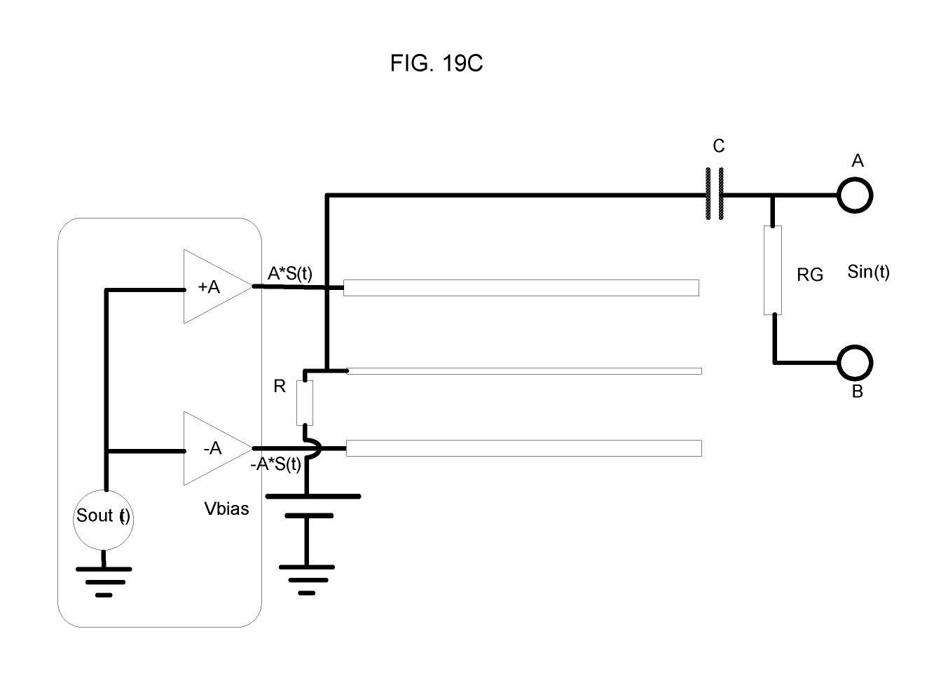

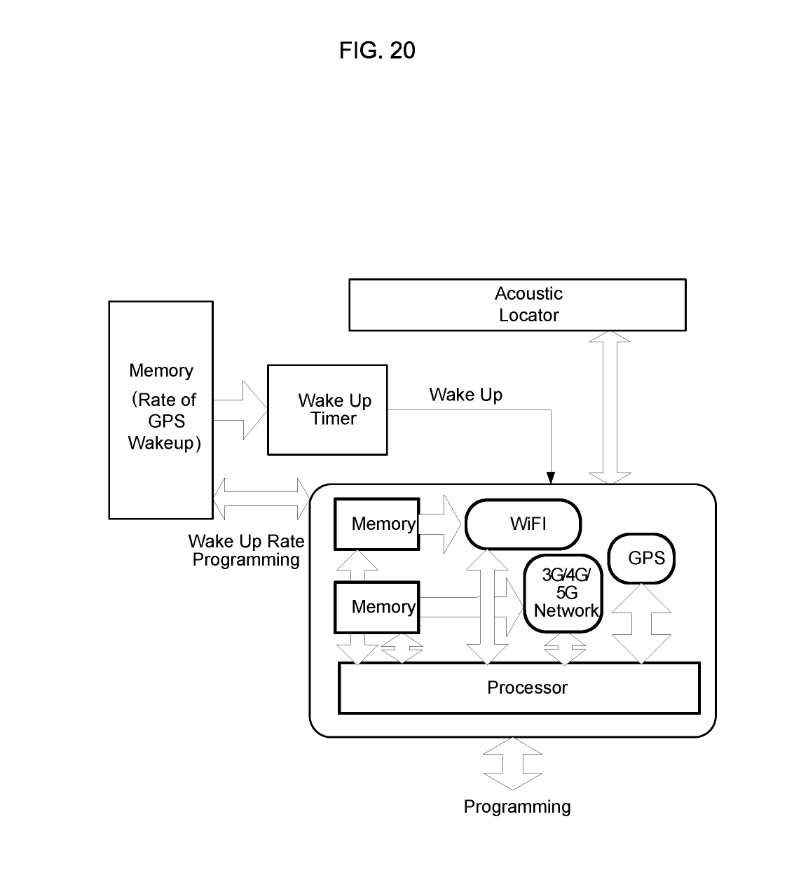

FIG. 19A is a simplified illustration of a floor plan of an acoustic locator, according to one exemplary embodiment.

FIG. 19B is a simplified illustration of a side view of an acoustic locator module, according to one exemplary embodiment.

FIG. 19C a simplified illustration of a microphone/speaker acoustic transducer, according to one exemplary embodiment.

The acoustic locator module is typically having a size of 4 mm×4 mm×1.5 mm. This size should include the silicon die, the external capacitors, the battery, the electro static speaker and a MEMS microphone, based on the same electro static speaker capacitor.

FIG. 19C shows how to connect the transmit/receive acoustic transducer to a source, for activating the speaker, and how to get a signal when it is activated as a microphone. These signals appear on nodes A and B and are connected to the ultra-low-power microphone buffers of FIGS. 8, 9 and 10.

Connection of the acoustic locator with a wireless cell phone network and Global Position System.

FIG. 20 is a simplified block diagram of a combination of an acoustic locator with wireless networks and a GPS device, according to one exemplary embodiment.

FIG. 20 describes a complete location finding system, combines with an acoustic locator system, which is used in nearby areas of up to 50 m-100 m distance. FIG. 20, describes a combination of an acoustic locator with a possible WiFi network, Cellular 3G, 4G (or possibly next generations), and having also a Global Positioning System (GPS).

In addition, this location system includes also a second location finding system, built of a WiFi system, a cellular wireless system, a GPS and a wake up mechanism. The 2nd localization system basically wakes up for a very small amount of time, every Twakeup (that may be 30 seconds up to a few days). Normally in wakeup, the 2nd localization system may send a beacon asking to join the network. This beacon may use about 3 watts in transmission, for a period of a few msec, and then the connection protocol may take place. We assume that in total, about 50 msec of 3 watts. So in 2 days Twakeup gives:

3×50e-3/(3600*24*2)=0.88 uwatts or about 0.29 ua current consumption.

Each time the 2nd location system wakes up, it connects to the network and gets parameters for the specific user. In case the user lost his phone, he may be able program his account to receive an SMS message whenever the 2nd location system wakes up, and to reprogram the rate of GPS and wireless, cellular network wake up period Twakeup. This is to enable the user to get updates of location every 30 sec, lminute, 3 minutes, 5 minutes, 10 minutes and etc.

The first time the user wants to program this system, he needs to have:

A user account setting for this system, where the user's GPS data and setting are stored (on the cloud).

Unique ID selected by him as described earlier,

Pre-program the 2nd location finding system which is based on WiFi. The user may have to define which WiFi network to use, passwords, etc.

The programming process may be done via a secured acoustic network or via the internet. The system may typically have an initial password in order to access its programming setup. This password should typically be masked in ROM and not be allowed to change, even when re-installing a new operating system into the smartphone. This may prevent cases where the phone is stolen and re-programmed.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations may be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. An acoustic locator comprising:
a microphone sensor;
an energy system; and
an ultra-low-power acoustic transceiver, electrically coupled to the microphone and to the energy system, and operative in a frequency range of 14000 Hz-20000 Hz.

2. The acoustic locator according to claim 1, wherein the ultra-low-power acoustic transceiver comprises an acoustic modem having an input electrically coupled to least one of an electrets microphone and a MEMS microphone, and an output electrically coupled to at least one of a speaker and an electrostatic speaker.

3. The acoustic locator according to claim 1, wherein the ultra-low-power acoustic transceiver is additionally electrically coupled to at least one of
a supply voltage;
a switch which is normally turned off; and
an ultra-low-power acoustic wakeup receiver.

4. The acoustic locator according to claim 3, additionally comprising an ultra-low-power acoustic wakeup receiver comprising:
an ultra-low-power input buffer/amplifier electrically coupled to least one of an electrets microphone and a MEMS microphone;
an ultra-low-power low-noise amplifier;
an ultra-low-power amplifier;
an ultra-low-power active band-pass filter;
an envelope/energy detector;
a first delay unit;
a comparator configured to compare between the instantaneous envelope energy and delayed energy;
a second delay unit connected to the comparator output;
a detector circuit configured to detect a threshold of at least one of voltage and current on the second delay; and
a memory unit configured to store the state of detection, which is connected to the threshold detector.

5. The acoustic locator according to claim 4, wherein at least one of the first and second delay comprise a passive low-pass-filter.

6. The acoustic locator according to claim 4, wherein the threshold detector comprises at least one of a Schmidt-trigger buffer and a Schmidt-trigger inverter.

7. The acoustic locator according to claim 4, wherein the threshold detector comprises a first comparator and a second threshold voltage connected to one node of comparator input.

8. The acoustic locator according to claim 4, wherein the threshold detector comprises at least one of a BJT transistor, a MOSFET transistor, and a JFET transistor.

9. The acoustic locator according to claim 1, wherein the energy system comprises:
an energy system circuit;
a first battery;
a second super-capacitor; and
a temperature control circuit to disconnect the battery from the energy circuit whenever temperature is out of a predefined temperature range.

10. The acoustic locator according to claim 1, wherein the energy system comprises
an energy system circuit;
a first battery;
a second super-capacitor;
a third energy harvested unit; and
a temperature control circuit to disconnect the battery from the energy circuit whenever temperature is out of a predefined temperature range.

11. The acoustic locator according to claim 1, wherein the energy system comprises:
an energy system circuit;
a first battery;
a second super-capacitor;
a third energy harvested unit; and
a temperature control circuit to disconnect the battery from the energy circuit whenever temperature is out of a predefined temperature range.

12. The acoustic locator according to claim 1, where the energy system comprises:
an energy system circuit;
a first battery;
a second super-capacitor;
a third energy harvested unit;
a fourth external energy source; and
a temperature control circuit to disconnect the battery from the energy circuit whenever temperature is out of a predefined temperature range.

13. The acoustic locator according to claim 12, wherein the energy circuit comprises a charging circuit for the super-capacitor.

14. The acoustic locator according to claim 13, wherein the charger is based on a constant current with a comparator that limits charging operation when voltage on the super-capacitor reaches a predefined voltage.

15. The acoustic locator according to claim 12, wherein the energy circuit comprises:
a first battery disconnection circuit to disconnect the battery whenever temperature is out of a predefined temperature range;
a second charging unit to charge the super-capacitor, having two inputs for source of energy, wherein a first input is the battery, and a second input is an external source; and
a third charging unit to charge the battery from the external source.

16. The acoustic locator according to claim 12, wherein the energy circuit comprises:
a first battery disconnection circuit to disconnect the battery whenever the temperature beyond a predefined temperature range; and
a second charging unit to charge the super-capacitor, having two inputs for source of energy, wherein the first is the battery, and the second is the external source.

17. An acoustic locator comprising:
a microphone;
a speaker;
an ultra-low-power acoustic transceiver;
a battery;
a super-capacitor; and
a memory storing RF network connection I.D.

18. The acoustic locator according to claim 17, additionally comprising:
a Global Positioning System (GPS) having dial-able control line putting the GPS on standby for low power.

19. A method for acoustic locating, the method comprising:
providing a microphone sensor; an energy system, and providing an ultra-low-power acoustic transceiver electrically coupled to the microphone and to the energy system; and
operating the ultra-low-power acoustic transceiver in a frequency range of 14000 Hz-20000 Hz.

20. The method according to claim 19, additionally comprising:
providing an acoustic modem;
electrically coupling an input of the acoustic modem to least one of an electrets microphone and a MEMS microphone; and
electrically coupling an output of the acoustic modem to at least one of a speaker and an electrostatic speaker.

21. The method according to claim 19, additionally coupling the ultra-low-power acoustic transceiver to at least one of
a supply voltage;
a switch which is normally turned off; and
an ultra-low-power acoustic wakeup receiver.

22. The method according to claim 21, wherein the ultra-low-power acoustic wakeup receiver comprises:
an ultra-low-power input buffer/amplifier electrically coupled to least one of an electrets microphone and a MEMS microphone;
an ultra-low-power low-noise amplifier;
an ultra-low-power amplifier;
an ultra-low-power active band-pass filter;
an envelope/energy detector;
a first delay unit;
a comparator configured to compare between the instantaneous envelope energy and delayed energy;
a second delay unit connected to the comparator output;
a detector circuit configured to detect a threshold of at least one of voltage and current on the second delay; and
a memory unit configured to store the state of detection, which is connected to the threshold detector.

23. The method according to claim 22, wherein at least one of the first and second delay comprise a passive low-pass-filter.

24. The method according to claim 22, wherein the threshold detector comprises at least one of a Schmidt-trigger buffer and a Schmidt-trigger inverter.

25. The method according to claim 22, wherein the threshold detector comprises a first comparator and a second threshold voltage connected to one node of comparator input.

26. The method according to claim 22, wherein the threshold detector comprises at least one of a BJT transistor, a MOSFET transistor, and a JFET transistor.

27. The method according to claim 19, wherein the energy system comprises:
an energy system circuit;
a first battery;
a second super-capacitor; and
a temperature control circuit to disconnect the battery from the energy circuit whenever temperature is out of a predefined temperature range.

28. The method according to claim 19, wherein the energy system comprises
an energy system circuit;
a first battery;
a second super-capacitor;
a third energy harvested unit; and
a temperature control circuit to disconnect the battery from the energy circuit whenever temperature is out of a predefined temperature range

29. The method according to claim 19, wherein the energy system comprises:
an energy system circuit;
a first battery;
a second super-capacitor;
a third energy harvested unit; and
a temperature control circuit to disconnect the battery from the energy circuit whenever temperature is out of a predefined temperature range.

30. The method according to claim 19, wherein the energy system comprises:
an energy system circuit;
a first battery;
a second super-capacitor;
a third energy harvested unit;
a fourth external energy source; and
a temperature control circuit to disconnect the battery from the energy circuit whenever temperature is out of a predefined temperature range.

31. The method according to claim 30, wherein the energy circuit comprises a charging circuit for the super-capacitor.

32. The method according to claim 31, wherein the charger is based on a constant current with a comparator that limits charging operation when voltage on the super-capacitor reaches a predefined voltage.

33. The method according to claim 30, wherein the energy circuit comprises:
a first battery disconnection circuit to disconnect the battery whenever temperature is out of a predefined temperature range;
a second charging unit to charge the super-capacitor, having two inputs for source of energy, wherein a first input is the battery, and a second input is an external source; and
a third charging unit to charge the battery from the external source.

34. The method according to claim 30, wherein the energy circuit comprises:
a first battery disconnection circuit to disconnect the battery whenever the temperature beyond a predefined temperature range; and
a second charging unit to charge the super-capacitor, having two inputs for source of energy, wherein the first is the battery, and the second is the external source.

35. A method for acoustic locating, the method comprising:
providing a microphone, a speaker, a battery, a super-capacitor, and a memory storing RF network connection I.D;
providing an ultra-low-power acoustic transceiver electrically coupled to the speaker, battery, super-capacitor, and memory; and
operating the ultra-low-power acoustic transceiver in a frequency range of 14000 Hz-20000 Hz.

36. The method according to claim 35, additionally comprising:
providing a Global Positioning System (GPS) having dial-able control line;
operating the GPS in standby mode.
